(19) United States
(12) Patent Application Publication
(10) Pub. No.: US 2026/0342990 A1
(43) Pub. Date: Oct. 29, 2026

(54) DECODING DEVICE, ENCODING DEVICE, DECODING METHOD, AND ENCODING METHOD

(71) Applicant: Panasonic Intellectual Property Corporation of America, Torrance, CA (US)

(72) Inventors: Jingying GAO, Singapore (SG); Han Boon TEO, Singapore (SG); Chong Soon LIM, Singapore (SG); Shen Yi LIM, Singapore (SG); Praveen Kumar YADAV, Singapore (SG); Kiyofumi ABE, Osaka (JP); Takahiro NISHI, Nara (JP); Toshiyasu SUGIO, Osaka (JP)

(21) Appl. No.: 19/716,645

(22) Filed: Jun. 23, 2026

Related U.S. Application Data
(63) Continuation of application No. PCT/JP2024/042251, filed on Nov. 28, 2024.
(60) Provisional application No. 63/615,125, filed on Dec. 27, 2023.

(51) Int. Cl. H04N 19/136; H04N 19/169; H04N 19/463

(52) U.S. Cl. CPC H04N 19/136; H04N 19/188; H04N 19/463

(57) ABSTRACT

A circuitry included in a decoder acquires, from a bitstream, first presence flag information indicating whether first video usability information is described in the bitstream, acquires the first video usability information from the bitstream in a case where the first presence flag information is a true value, acquires, from the bitstream, first extension flag information indicating whether second video usability information is described in the bitstream, acquires the second video usability information from the bitstream in a case where the first extension flag information is a true value, acquires, from the bitstream, second extension flag information indicating whether the bitstream includes a description of first extension information extending other information of a network abstraction layer (NAL) unit in which the second video usability information is described, and acquires the first extension information from the bitstream in a case where the second extension flag information is a true value.

### FIELD OF INVENTION

The present disclosure relates to a decoder, an encoder, a decoding method, and an encoding method.

### BACKGROUND ART

Patent Literature 1 discloses an image processing system according to the background art. The image processing system includes an encoder (encoding device) and a decoder (decoding device). The encoder receives an input image having various modalities. The encoder extracts a feature from the input image and transmits the feature thus extracted to the decoder. The decoder executes an image analysis task in accordance with the feature thus received to output a segmentation map.

However, in the background art, a method of extending a video usability information (VUI) parameter in an encoder and a decoder compatible with advanced video coding (AVC) (H.264) or high efficiency video coding (HEVC) (H.265), which are existing video coding standards, has not been studied at all.

Patent Literature 1: US 2024-0046453 A

### SUMMARY OF THE INVENTION

An object of the present disclosure is to obtain a decoder, an encoder, a decoding method, and an encoding method capable of appropriately extending a video usability information (VUI) parameter in an existing video coding standard.

A decoder according to an aspect of the present disclosure includes circuitry and a memory connected to the circuitry, in which the circuitry acquires, from a bitstream, first presence flag information indicating whether first video usability information is described in the bitstream, acquires the first video usability information from the bitstream in a case where the first presence flag information is a true value, acquires, from the bitstream, first extension flag information indicating whether second video usability information is described in the bitstream, acquires the second video usability information from the bitstream in a case where the first extension flag information is a true value, acquires, from the bitstream, second extension flag information indicating whether the bitstream includes a description of first extension information extending other information of a network abstraction layer (NAL) unit in which the second video usability information is described, and acquires the first extension information from the bitstream in a case where the second extension flag information is a true value.

### BRIEF DESCRIPTION OF THE DRAWINGS

FIG. 1 is a simplified diagram showing a configuration of an image processing system according to an embodiment of the present disclosure.

FIG. 2 is a simplified diagram showing a configuration of circuitry included in an encoder.

FIG. 3 is a flowchart showing processing executed by the circuitry included in the encoder.

FIG. 4 is a simplified diagram showing a configuration of a bitstream.

FIG. 5 is a simplified diagram showing an example of syntax of a VUI parameter.

FIG. 6 is a diagram showing an example of correspondence between a value of vui_modality_type and an image type.

FIG. 7 is a simplified diagram showing an example of the syntax of the VUI parameter.

FIG. 8 is a simplified diagram showing an example of the syntax of the VUI parameter.

FIG. 9 is a simplified diagram showing an example of the syntax of the VUI parameter.

FIG. 10 is a diagram showing an example of correspondence between an index value and wavelength information.

FIG. 11 is a simplified diagram showing an example of the syntax of the VUI parameter.

FIG. 12 is a simplified diagram showing an example of the syntax of the VUI parameter.

FIG. 13 is a diagram showing an example of correspondence between values of representation type information and interpretation of each value.

FIG. 14 is a simplified diagram showing an example of the syntax of the VUI parameter.

FIG. 15 is a diagram showing an example of correspondence between values of interpolation information and interpretation of each value.

FIG. 16 is a diagram showing a configuration example of the bitstream.

FIG. 17 is a simplified diagram showing a configuration of circuitry included in a decoder.

FIG. 18 is a flowchart showing processing executed by the circuitry included in the decoder.

FIG. 19 is a simplified diagram showing an example of table information.

FIG. 20 is a simplified diagram showing an example of the table information.

FIG. 21 is a block diagram showing an example of a functional configuration of an encoding unit.

FIG. 22 is a diagram showing an example of data hierarchical structure in a stream.

FIG. 23 is a block diagram showing an example of a functional configuration of a decoding unit.

FIG. 24 is a simplified diagram showing a first example of syntax of SPS in high efficiency video coding (HEVC).

FIG. 25 is a simplified diagram showing an example of syntax of first video usability information in HEVC or advanced video coding (AVC).

FIG. 26 is a simplified diagram showing a second example of the syntax of SPS in HEVC.

FIG. 27 is a simplified diagram showing a first example of the syntax of SPS in AVC.

FIG. 28 is a simplified diagram showing the first example of the syntax of SPS in AVC.

FIG. 29 is a simplified diagram showing a second example of the syntax of SPS in AVC.

FIG. 30 is a simplified diagram showing a first example of syntax of second video usability information in HEVC or AVC.

FIG. 31 is a simplified diagram showing a second example of the syntax of the second video usability information in HEVC or AVC.

FIG. 32 is a simplified diagram showing a third example of the syntax of the second video usability information in HEVC or AVC.

### DETAILED DESCRIPTION

### Knowledge Underlying Present Disclosure

The image processing system according to the background art includes an encoder and a decoder. The encoder receives an input image having various modalities. The encoder extracts a feature from the input image and transmits the feature thus extracted to the decoder. The decoder executes an image analysis task in accordance with the feature thus received to output a segmentation map.

The decoder executes task processing including a human vision and a machine task. The human vision means visual recognition or viewing of a moving image by a human being such as an operator or a user. The machine task includes various types of task processing with use of an AI model, such as object detection, object tracking, object segmentation, action recognition, or pose estimation.

In the background art, image-related information such as modality information indicating an image type is not transmitted from the encoder to the decoder. This may lead to failure in selection of the most appropriate task processing according to an image type of the input image, thereby deteriorating execution accuracy of task processing. Therefore, in the present disclosure, an encoder includes image-related information such as modality information in a bitstream and transmits the bitstream to a decoder, and the decoder executes optimal task processing in accordance with an image type indicated by the modality information, thereby improving execution accuracy.

A header region of the bitstream includes video usability information (VUI), and a VUI parameter provides information regarding image characteristics such as an aspect ratio of an image. Along with an increase in video applications, in versatile video coding (VVC) (H.266), which is a next-generation video coding standard, it has been studied to extend and include image-related information such as modality information in the VUI parameter. However, in advanced video coding (AVC) (H.264) or high efficiency video coding (HEVC) (H.265) which is an existing video coding standard, the VUI parameter cannot be directly extended. Therefore, an encoder and a decoder compatible with AVC or HEVC cannot appropriately process image-related information such as modality information extended to the VUI parameter.

In order to solve such a problem, the present inventors have found that the above problem can be solved by appropriately hierarchizing syntax of a sequence parameter set (SPS) by using extension flag information, and have arrived at the present disclosure.

Next, each aspect of the present disclosure will be described.

A decoder according to a first aspect of the present disclosure includes circuitry and a memory connected to the circuitry, in which the circuitry acquires, from a bitstream, first presence flag information indicating whether first video usability information is described in the bitstream, acquires the first video usability information from the bitstream in a case where the first presence flag information is a true value, acquires, from the bitstream, first extension flag information indicating whether second video usability information is described in the bitstream, acquires the second video usability information from the bitstream in a case where the first extension flag information is a true value, acquires, from the bitstream, second extension flag information indicating whether the bitstream includes a description of first extension information extending other information of a network abstraction layer (NAL) unit in which the second video usability information is described, and acquires the first extension information from the bitstream in a case where the second extension flag information is a true value.

According to the first aspect, video usability information can be appropriately extended by the first extension flag information and the second video usability information. The second extension flag information and the first extension information can appropriately extend other information of the NAL unit in which the second video usability information is described.

In a decoder according to a second aspect of the present disclosure, in the first aspect, the circuitry preferably acquires the first presence flag information, the first video usability information, the first extension flag information, the second video usability information, the second extension flag information, and the first extension information from a same NAL unit.

The second aspect can be compatible with HEVC (H.265) that is an existing video coding standard.

In a decoder according to a third aspect of the present disclosure, in the second aspect, the circuitry preferably acquires the second video usability information from the NAL unit in a case where the first extension flag information is a true value and the first presence flag information is a true value.

According to the third aspect, in a case where the first presence flag information is a false value (that is, in a case where the first video usability information is not included in the bitstream), a code amount can be reduced by not including the second video usability information in the bitstream.

In a decoder according to a fourth aspect of the present disclosure, in the first aspect, the circuitry preferably acquires the first presence flag information and the first video usability information from a first NAL unit, and preferably acquires the first extension flag information, the second video usability information, the second extension flag information, and the first extension information from a second NAL unit.

The fourth aspect can be compatible with AVC (H.264) that is an existing video coding standard.

In a decoder according to a fifth aspect of the present disclosure, in the fourth aspect, the circuitry preferably acquires, from the second NAL unit, second presence flag information indicating whether the first video usability information is described in the bitstream, and in a case where the first extension flag information is a true value and the second presence flag information is a true value, the circuitry preferably acquires the second video usability information from the second NAL unit.

According to the fifth aspect, in a case where the second presence flag information is a false value (that is, in a case where the first video usability information is not included in the bitstream), the code amount can be reduced by not including the second video usability information in the bitstream.

In a decoder according to a sixth aspect of the present disclosure, in the first aspect, the circuitry preferably acquires image-related information related to an image included in the bitstream from the second video usability information, and in a case where second extension information that further extends the second video usability information is described in the second video usability information, the circuitry preferably acquires, from the second video usability information, size information indicating a size of the second extension information, and preferably acquires the second extension information from the second video usability information on a basis of the size information.

According to the sixth aspect, video usability information can be further extended by the second extension information. The second extension information can be appropriately acquired from the second video usability information by the size information.

In a decoder according to a seventh aspect of the present disclosure, in the first aspect, the circuitry preferably acquires image-related information related to an image included in the bitstream from the second video usability information, acquires, from the second video usability information, third extension flag information indicating whether second extension information that further extends the second video usability information is described in the second video usability information, and in a case where the third extension flag information is a true value, the circuitry preferably acquires the second extension information from the second video usability information.

According to the seventh aspect, the video usability information can be further extended by the third extension flag information and the second extension information.

In a decoder according to an eighth aspect of the present disclosure, in the first aspect, the first extension information preferably includes a bit string continuous up to a terminal bit of an NAL unit that stores the first extension information.

According to the eighth aspect, the first extension information can be easily and appropriately acquired from the NAL unit that stores the first extension information.

In a decoder according to a ninth aspect of the present disclosure, in the seventh aspect, the second extension information preferably includes a bit string continuous up to a terminal bit of an NAL unit that stores the second extension information.

According to the ninth aspect, the second extension information can be easily and appropriately acquired from the NAL unit that stores the second extension information.

In a decoder according to a tenth aspect of the present disclosure, in the first aspect, the second video usability information preferably includes image-related information related to an image included in the bitstream, and in a case where the first extension flag information is a true value in the decoder that does not allow interpretation of the image-related information, the circuitry preferably ignores the second video usability information, the second extension flag information, and the first extension information.

According to the tenth aspect, by ignoring the second video usability information, the second extension flag information, and the first extension information, it is possible to avoid execution of useless processing by the decoder.

In a decoder according to an eleventh aspect of the present disclosure, in the first aspect, the second video usability information preferably includes image-related information related to an image included in the bitstream, in the decoder that allows interpretation of the image-related information but does not allow interpretation of the first extension information, in a case where the first extension flag information is a true value, the circuitry preferably acquires the second video usability information and the second extension flag information from the bitstream, and in a case where the second extension flag information is a true value, the circuitry preferably ignores the first extension information.

According to the eleventh aspect, by ignoring the first extension information, it is possible to avoid execution of useless processing by the decoder.

An encoder according to a twelfth aspect of the present disclosure includes circuitry, and a memory connected to the circuitry, in which the circuitry encodes, into a bitstream, first presence flag information indicating whether first video usability information is described in the bitstream, encodes the first video usability information into the bitstream in a case where the first presence flag information is a true value, encodes, into the bitstream, first extension flag information indicating whether second video usability information is described in the bitstream, encodes the second video usability information into the bitstream in a case where the first extension flag information is a true value, encodes, into the bitstream, second extension flag information indicating whether the bitstream includes a description of first extension information extending other information of a network abstraction layer (NAL) unit in which the second video usability information is described, and encodes the first extension information into the bitstream in a case where the second extension flag information is a true value.

According to the twelfth aspect, the video usability information can be appropriately extended by the first extension flag information and the second video usability information. The second extension flag information and the first extension information can appropriately extend other information of the NAL unit in which the second video usability information is described.

In an encoder according to a thirteenth aspect of the present disclosure, in the twelfth aspect, the circuitry preferably encodes the first presence flag information, the first video usability information, the first extension flag information, the second video usability information, the second extension flag information, and the first extension information into a same NAL unit.

The thirteenth aspect can be compatible with HEVC (H.265) that is an existing video coding standard.

In an encoder according to a fourteenth aspect of the present disclosure, in the thirteenth aspect, the circuitry preferably encodes the second video usability information into the NAL unit in a case where the first extension flag information is a true value and the first presence flag information is a true value.

According to the fourteenth aspect, in a case where the first presence flag information is a false value (that is, in a case where the first video usability information is not included in the bitstream), the code amount can be reduced by not including the second video usability information in the bitstream.

In an encoder according to a fifteenth aspect of the present disclosure, in the twelfth aspect, the circuitry preferably encodes the first presence flag information and the first video usability information into a first NAL unit, and preferably encodes the first extension flag information, the second video usability information, the second extension flag information, and the first extension information into a second NAL unit.

The fifteenth aspect can be compatible with AVC (H.264) that is an existing video coding standard.

In an encoder according to a sixteenth aspect of the present disclosure, in the fifteenth aspect, the circuitry preferably encodes, into the second NAL unit, second presence flag information indicating whether the first video usability information is described in the bitstream, and in a case where the first extension flag information is a true value and the second presence flag information is a true value, the circuitry preferably encodes the second video usability information into the second NAL unit.

According to the sixteenth aspect, in a case where the second presence flag information is a false value (that is, in a case where the first video usability information is not included in the bitstream), the code amount can be reduced by not including the second video usability information in the bitstream.

In an encoder according to a seventeenth aspect of the present disclosure, in the twelfth aspect, the circuitry preferably encodes image-related information related to an image included in the bitstream into the second video usability information, and in a case where second extension information that further extends the second video usability information is described in the second video usability information, the circuitry preferably encodes, into the second video usability information, size information indicating a size of the second extension information, and preferably encodes the second extension information into the second video usability information on a basis of the size information.

According to the seventeenth aspect, the second video usability information can be further extended by the second extension information. The decoder can appropriately acquire the second extension information from the second video usability information by the size information.

In an encoder according to an eighteenth aspect of the present disclosure, in the twelfth aspect, the circuitry preferably encodes image-related information related to an image included in the bitstream into the second video usability information, and encodes, into the second video usability information, third extension flag information indicating whether second extension information that further extends the second video usability information is described in the second video usability information, and in a case where the third extension flag information is a true value, the circuitry preferably encodes the second extension information into the second video usability information.

According to the eighteenth aspect, the second video usability information can be further extended by the third extension flag information and the second extension information.

In an encoder according to a nineteenth aspect of the present disclosure, in the twelfth aspect, the first extension information preferably includes a bit string continuous up to a terminal bit of an NAL unit that stores the first extension information.

According to the nineteenth aspect, the first extension information can be easily and appropriately encoded into the NAL unit that stores the first extension information.

In an encoder according to a twentieth aspect of the present disclosure, in the eighteenth aspect, the second extension information preferably includes a bit string continuous up to a terminal bit of an NAL unit that stores the second extension information.

According to the twentieth aspect, the second extension information can be easily and appropriately encoded into the NAL unit that stores the second extension information.

In an encoder according to a twenty-first aspect of the present disclosure, in the twelfth aspect, the second video usability information preferably includes image-related information related to an image included in the bitstream, in the encoder that does not allow interpretation of the image-related information, the circuitry preferably encodes the first extension flag information that is a false value into the bitstream, and the circuitry preferably does not encode the second video usability information, the second extension flag information, and the first extension information into the bitstream.

According to the twenty-first aspect, by not encoding the second video usability information, the second extension flag information, and the first extension information, it is possible to avoid execution of useless processing by the encoder.

In the encoder according to a twenty-second aspect of the present disclosure, in the twelfth aspect, the second video usability information preferably includes image-related information related to an image included in the bitstream, in the encoder that allows interpretation of the image-related information and does not allow interpretation of the first extension information, the circuitry preferably encodes the first extension flag information that is a true value, the second extension flag information that is a false value, and the second video usability information into the bitstream, and does not encode the first extension information into the bitstream.

According to the twenty-second aspect, by not encoding the first extension information, it is possible to avoid execution of useless processing by the encoder.

A decoding method according to a twenty-third aspect of the present disclosure includes, by a decoder, acquiring, from a bitstream, first presence flag information indicating whether first video usability information is described in the bitstream, acquiring the first video usability information from the bitstream in a case where the first presence flag information is a true value, acquiring, from the bitstream, first extension flag information indicating whether second video usability information is described in the bitstream, acquiring the second video usability information from the bitstream in a case where the first extension flag information is a true value, acquiring, from the bitstream, second extension flag information indicating whether the bitstream includes a description of first extension information extending other information of a network abstraction layer (NAL) unit in which the second video usability information is described, and acquiring the first extension information from the bitstream in a case where the second extension flag information is a true value.

According to the twenty-third aspect, the video usability information can be appropriately extended by the first extension flag information and the second video usability information. The second extension flag information and the first extension information can appropriately extend other information of the NAL unit in which the second video usability information is described.

An encoding method according to a twenty-fourth aspect of the present disclosure includes, by an encoder, encoding, into a bitstream, first presence flag information indicating whether first video usability information is described in the bitstream, encoding the first video usability information into the bitstream in a case where the first presence flag information is a true value, encoding, into the bitstream, first extension flag information indicating whether second video usability information is described in the bitstream, encoding the second video usability information into the bitstream in a case where the first extension flag information is a true value, encoding, into the bitstream, second extension flag information indicating whether the bitstream includes a description of first extension information extending other information of a network abstraction layer (NAL) unit in which the second video usability information is described, and encoding the first extension information into the bitstream in a case where the second extension flag information is a true value.

According to the twenty-fourth aspect, the video usability information can be appropriately extended by the first extension flag information and the second video usability information. The second extension flag information and the first extension information can appropriately extend other information of the NAL unit in which the second video usability information is described.

### Embodiments of Present Disclosure

Embodiments of the present disclosure will be described below in detail with reference to the drawings. Note that elements denoted by the same reference signs in different drawings represent the same or corresponding elements.

Note that each embodiment described below shows one specific example of the present disclosure. Numerical values, shapes, constituent elements, steps, orders of the steps, and the like of the following embodiments are merely examples, and are not intended to limit the present disclosure. A constituent element not described in an independent claim representing the highest concept among constituent elements in the following embodiments is described as an optional constituent element. In all the embodiments, contents can be replaced or combined. Note that these general or specific aspects may be achieved by means of a system, a method, an integrated circuitry, a computer program, or a computer-readable recording medium such as a CD-ROM, or may be achieved by an optional combination of the system, the method, the integrated circuitry, the computer program, and the recording medium.

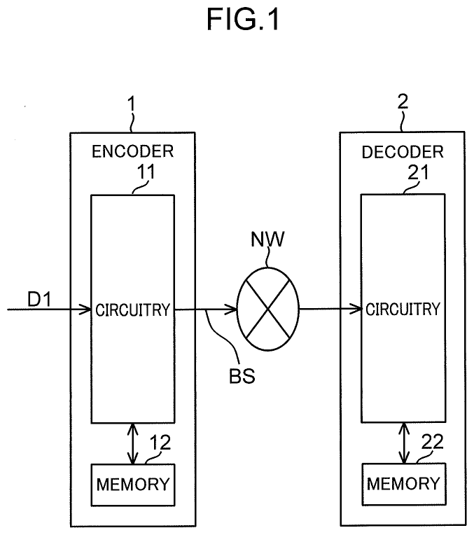

FIG. 1 is a simplified diagram showing a configuration of an image processing system according to an embodiment of the present disclosure. The image processing system includes an encoder 1, a decoder 2, and a transmission path NW.

The encoder 1 receives image data D1 input from an external device. Examples of the external device include a camera that captures a moving image. The external device inputs, to the encoder 1, the image data D1 of a captured moving image.

The encoder 1 generates a bitstream BS on the basis of the image data D1. Here, a bitstream is a data string of digital data or a flow of the digital data. The bitstream (or simply the stream) may be constituted by a single stream or a plurality of streams divided into a plurality of hierarchical layers. The bitstream may be transmitted by serial communication through a single transmission path or by packet communication through a plurality of transmission paths. The encoder 1 transmits the bitstream BS thus generated to the decoder 2 via the transmission path NW. The decoder 2 receives the bitstream BS.

The decoder 2 decodes the image data D1 from the bitstream BS, and executes task processing in accordance with the image data D1 thus decoded. The task processing includes a human vision and a machine task. The human vision means visual recognition or viewing of a moving image by a human being such as an operator or a user. The machine task includes various types of task processing such as object detection, object tracking, object segmentation, action recognition, and pose estimation with use of artificial intelligence (AI) models as machine-learned estimation models. A task processor configured to execute the human vision includes a display device such as a liquid crystal display or an organic EL display. A task processor executing the machine task includes an inference device using AI.

The transmission path NW is the Internet, a wide area network (WAN), a local area network (LAN), or an optional combination of the above. The transmission path NW is desirably a private network or the like in which secure communication is ensured by access restriction.

The encoder 1 includes circuitry 11 and a memory 12 connected to the circuitry 11. The circuitry 11 includes a processor such as a CPU. The memory 12 includes any recording medium such as a ROM, a RAM, an HDD, an SSD, or a semiconductor memory. The memory 12 stores data to be processed or data being processed by the circuitry 11, and the like.

The decoder 2 includes circuitry 21 and a memory 22 connected to the circuitry 21. The circuitry 21 includes a processor such as a CPU. The memory 22 includes any recording medium such as a ROM, a RAM, an HDD, an SSD, or a semiconductor memory. The memory 22 stores data to be processed or data being processed by the circuitry 21, and the like.

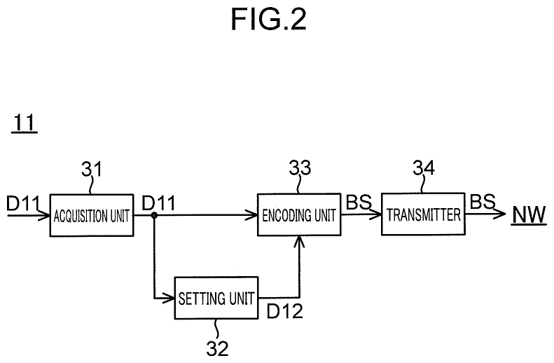

FIG. 2 is a simplified diagram showing a configuration of the circuitry 11 included in the encoder 1. The circuitry 11 includes an acquisition unit 31, a setting unit 32, an encoding unit 33, and a transmitter 34.

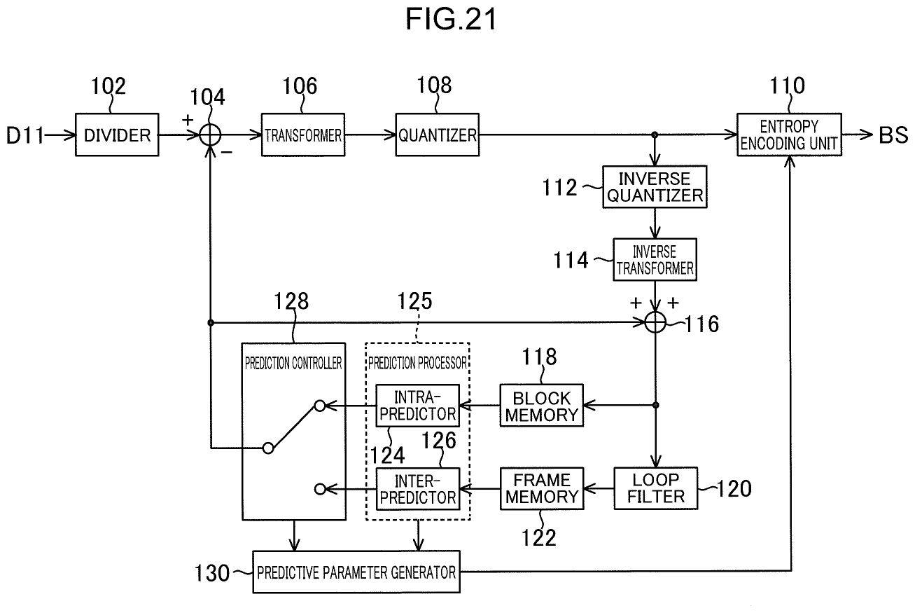

Next, description will be made on the encoding unit 33 according to the present embodiment. FIG. 21 is a block diagram showing an example of a functional configuration of the encoding unit 33 according to the present embodiment. The encoding unit 33 encodes an image in block units.

As shown in FIG. 21, the encoding unit 33 includes a divider 102, a subtractor 104, a transformer 106, a quantizer 108, an entropy encoding unit 110, an inverse quantizer 112, an inverse transformer 114, an adder 116, a block memory 118, a loop filter 120, a frame memory 122, an intra-predictor 124, an inter-predictor 126, a prediction controller 128, and a predictive parameter generator 130. Note that the intra-predictor 124 and the inter-predictor 126 constitute part of a prediction processor 125.

For example, the encoding unit 33 shown in FIG. 21 includes a plurality of constituent elements implemented by the circuitry 11 and the memory 12 shown in FIG. 1.

The circuitry 11 includes a processor such as a CPU. The circuitry 11 may be constituted by an electronic circuitry dedicated or generalized to image encoding, or by an assembly of a plurality of electronic circuitrys. For example, the circuitry 11 may function as a plurality of constituent elements except for a constituent element for information storage, out of the plurality of constituent elements included in the encoding unit 33 shown in FIG. 21.

The memory 12 may be a dedicated or generalized electronic circuitry to store information, or an assembly of a plurality of electronic circuitrys. The memory 12 may be externally connected to the circuitry 11 or may be incorporated in the circuitry 11. The memory 12 may be a magnetic disk, an optical disk, or the like, or may be expressed as a storage, a recording medium, or the like. The memory 12 may be a nonvolatile memory or a volatile memory.

The memory 12 may store an image to be encoded, or a stream corresponding to an encoded image. The memory 12 may store a program for a processor to execute image encoding processing.

The memory 12 may function as the constituent element for information storage, out of the plurality of constituent elements included in the encoding unit 33 shown in FIG. 21. Specifically, the memory 12 may function as the block memory 118 and the frame memory 122 shown in FIG. 21. More specifically, the memory 12 may store a reconstructed image (specifically, a reconstructed block, a reconstructed picture, or the like).

Note that in the encoding unit 33, part of the plurality of constituent elements shown in FIG. 21 is not required to be mounted, and part of a plurality of processing executed by the plurality of constituent elements is not required to be executed. Alternatively, part of the plurality of constituent elements shown in FIG. 21 may be mounted on a different device, and part of the plurality of processing executed by the plurality of constituent elements may be executed by the different device.

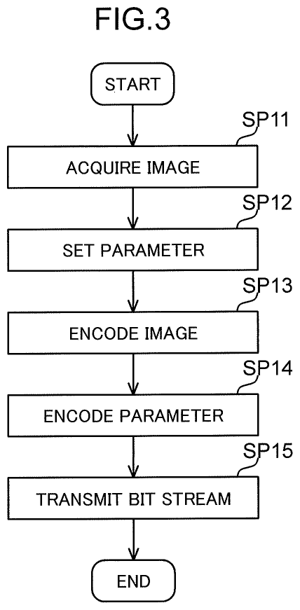

FIG. 3 is a flowchart showing processing executed by the circuitry 11 included in the encoder 1.

First, in step SP11, the acquisition unit 31 acquires image data D11 indicating an image Q as a processing target received from an external device. The image data D11 corresponds to the image data D1 indicated in FIG. 1.

Next, in step SP12, the setting unit 32 sets a parameter P in association with the image Q. The parameter P includes a first parameter P1, a second parameter P2, a third parameter P3, and a fourth parameter P4. The first parameter P1 includes modality information indicating an image type of the image Q. The second parameter P2 includes wavelength information indicating a wavelength band of light emission of the image Q. The third parameter P3 includes color information of the image Q. The fourth parameter P4 includes extension bit information corresponding to a spare image type in a case where the modality information indicates that the image type is a spare image type for extension. The setting unit 32 inputs data D12 including setting information of the parameter P to the encoding unit 33.

The first parameter P1 includes modality information indicating an image type of the image Q. The image type includes at least one of a visible light image, an infrared image, and an ultraviolet image, for example. The visible light image includes a natural image, an RGB image, or the like, and is used for provision of detailed color information for the human vision or the machine task, and the like. The infrared image includes an image captured by using an infrared camera, or the like, and is used for imaging in the dark, and the like. The ultraviolet image includes an image captured by using an ultraviolet camera, or the like, and is used for detecting a product flaw, and the like. The modality information indicates that the image type is at least one of the visible light image, the infrared image, and the ultraviolet image. The modality information indicates at least one of the following: the image type is not defined; and the image type is a spare image type for extension. That is, the modality information indicates that the image type is at least one of the visible light image, the infrared image, the ultraviolet image, an undefined image type, and the spare image type for extension. Note that the modality information may include other image types. The setting unit 32 may set the first parameter P1 through image analysis based on the image data D11, or may set the first parameter P1 on the basis of setting information input by an operator of the encoder 1.

Next, in step SP13, the encoding unit 33 encodes, into the bitstream BS, the image Q indicated by the image data D11 input from the acquisition unit 31.

Next, in step SP14, the encoding unit 33 encodes, into the bitstream BS, the parameter P indicated by the data D12 input from the setting unit 32. Herein, encoding the parameter P into the bitstream BS may be expressed as retaining the parameter P in the bitstream BS or storing the parameter P in the bitstream BS. Processing in step SP13 and processing in step SP14 may be executed in inverse order of the example in FIG. 3, or may be executed simultaneously.

Next, in step SP15, the transmitter 34 transmits the bitstream BS received from the encoding unit 33 to the decoder 2 via the transmission path NW.

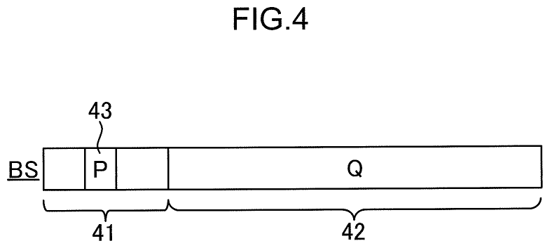

FIG. 4 is a simplified diagram showing a configuration of the bitstream BS. The bitstream BS includes a header region 41 and a payload region 42. The encoding unit 33 stores encoded data of the image Q in the payload region 42, and stores encoded data of the parameter P associated with the image Q in the header region 41.

The encoding unit 33 may encode the encoded data of the parameter P in a predetermined region 43 in the header region 41. The predetermined region 43 may correspond to video usability information (VUI) or supplemental enhancement information (SEI). However, the predetermined region 43 is not limited to the VUI or the SEI, but may be VPS, SPS, PPS, PH, SH, APS, a tile header, a system layer header, or the like.

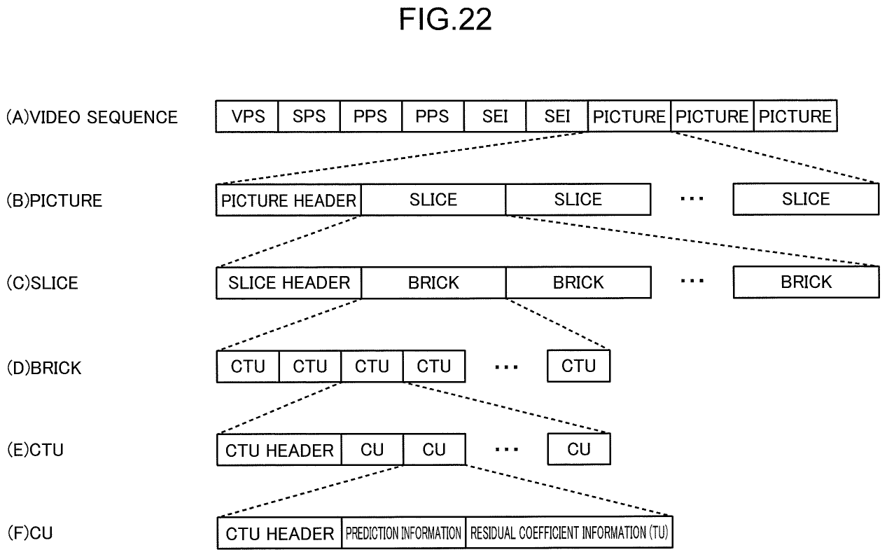

FIG. 22 is a diagram showing an example of data hierarchical structure in a stream. The stream includes a video sequence, for example. As shown in (A) in FIG. 22, the video sequence includes, for example, a video parameter set (VPS), a sequence parameter set (SPS), a picture parameter set (PPS), supplemental enhancement information (SEI), and a plurality of pictures.

The VPS includes, in a moving image constituted by a plurality of layers, an encoded parameter common to the plurality of layers, and an encoded parameter associated with the plurality of layers or an individual layer included in the moving image.

The SPS includes a parameter used for a sequence, that is, an encoded parameter to be referred to by the decoder 2 for decoding of the sequence. The encoded parameter may indicate, for example, a width or a height of a picture. Note that a plurality of SPSs may be present.

The PPS includes a parameter used for a picture, that is, an encoded parameter to be referred to by the decoder 2 for decoding of each picture in a sequence. The encoded parameter may include, for example, a reference value of a quantization width to be used for picture decoding, and a flag indicating application of weighted prediction. Note that a plurality of PPSs may be present. The SPS and the PPS may simply be called a parameter set.

As shown in (B) in FIG. 22, a picture includes a picture header and one or more slices. The picture header includes an encoded parameter to be referred to by the decoder 2 for decoding of the one or more slices.

As shown in (C) in FIG. 22, the slice includes a slice header and one or more bricks. The slice header includes an encoded parameter to be referred to by the decoder 2 for decoding of the one or more bricks.

As shown in (D) in FIG. 22, the brick includes one or more coding tree units (CTUs).

Note that the picture may include no slice, and may include a tile group instead of the slice. In this case, the tile group includes one or more tiles. The brick may include a slice.

The CTU is also called a super block or a basic division unit. As shown in (E) in FIG. 22, the CTU includes a CTU header and one or more coding units (CUs). The CTU header includes an encoded parameter to be referred to by the decoder 2 for decoding of the one or more CUs.

The CU may be divided into a plurality of small CUs. As shown in (F) in FIG. 22, the CU includes a CU header, prediction information, and residual coefficient information. The prediction information is information for prediction of a CU. The residual coefficient information is information indicating a prediction residual. Note that the CU is basically identical to a prediction unit (PU) or a transform unit (TU), but may include a plurality of TUs smaller than the CU. The CU may be processed for each of virtual pipeline decoding units (VPDUs) constituting the CU. The VPDU is, for example, a fixed unit processible at one stage upon pipeline processing in hardware.

Note that the stream is not required to include part of the plurality of hierarchical layers shown in FIG. 22. These hierarchical layers may be changed in terms of their order, and any of the hierarchical layers may be replaced with another hierarchical layer.

A picture as a target of processing executed by a device such as the encoder 1 or the decoder 2 at a current time point is referred to as a current picture. The current picture has the same meaning as an encoding target picture when the processing is encoding, and the current picture has the same meaning as a decoding target picture when the processing is decoding. A block (a CU or a block of a CU) as a target of processing executed by a device such as the encoder 1 or the decoder 2 at a current time point is referred to as a current block. The current block has the same meaning as an encoding target block when the processing is encoding, and the current block has the same meaning as a decoding target block when the processing is decoding.

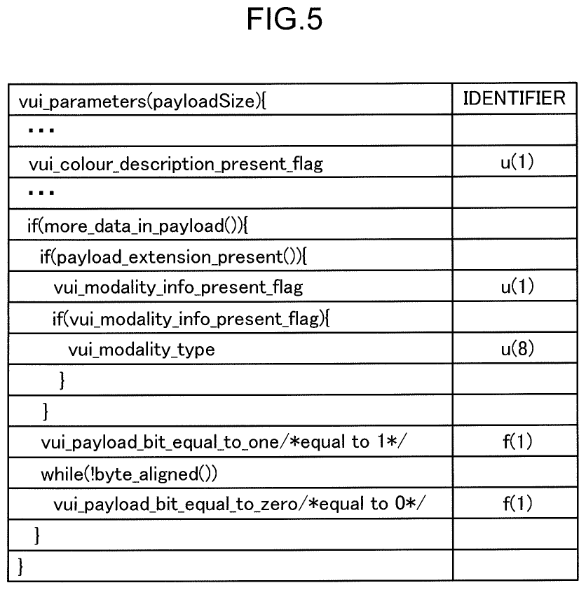

FIG. 5 is a simplified diagram showing an example of syntax of the VUI parameter including the first parameter P1 and the third parameter P3.

The first parameter P1 includes flag information (vui_modality_info_present_flag) indicating whether the modality information is described in the bitstream BS. In a case where the value of vui_modality_info_present_flag is 1, this indicates that the modality information is present within the VUI parameter. In a case where the value of vui_modality_info_present_flag is 0, this indicates that the modality information is not present within the VUI parameter. In a case where vui_modality_info_present_flag indicates that the modality information is described in the bitstream BS, the modality information is represented as an identifier value of vui_modality_type included in the VUI parameter.

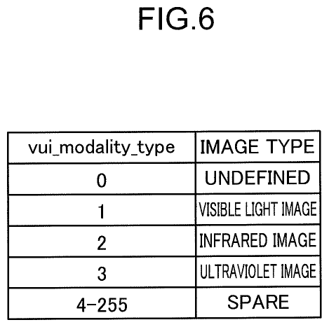

FIG. 6 is a diagram showing an example of the correspondence between the value of vui_modality_type and the image type. As shown in FIG. 6, in a case where the value of vui_modality_type is 0, this indicates that the image type of the image Q is not defined (that is, undefined). In a case where the value of vui_modality_type is 1, this indicates that the image type of the image Q is the visible light image. In a case where the value of vui_modality_type is 2, this indicates that the image type of the image Q is the infrared image. In a case where the value of vui_modality_type is 3, this indicates that the image type of the image Q is the ultraviolet image. Other values of vui_modality_type (4-255 in this example) indicate a spare region reserved for future extension use. Note that the number of image types defined in FIG. 6 may be increased depending on the image Q as a processing target. In a case where vui_modality_type is not present, this may mean that the value of vui_modality_type is 0. In a case where the value of vui_modality_type is 0, the wavelength information indicating a wide wavelength band spanning multiple image types such as hyperspectral images may be able to be defined by user settings or the like.

As shown in FIG. 5, the third parameter P3 includes flag information (vui_colour_description_present_flag) indicating whether color information is described in the bitstream BS. In a case where the value of vui_colour_description_present_flag is 1, this indicates that the color information is present in the VUI parameter. In a case where the value of vui_colour_description_present_flag is 0, this indicates that no color information is present in the VUI parameter. Although not shown, the color information includes vui_colour_primaries, vui_trasfer_characteristics, and vui_matrix_coeffs, and the like. Note that in a case where the image type is the infrared image or the ultraviolet image, the third parameter P3 is not required to include color information. In the encoding processing, in a case where the image type indicated by the modality information is the visible light image, the encoder 1 sets the value of vui_colour_description_present_flag to 1 and describes the color information in the VUI parameter. Meanwhile, in a case where the image type indicated by the modality information is the infrared image or the ultraviolet image, the encoder 1 sets the value of vui_colour_description_present_flag to 0 and does not describe the color information in the VUI parameter. In decoding processing, in a case where the image type indicated by the modality information is the visible light image, the decoder 2 acquires the color information from the bitstream BS. Meanwhile, in a case where the image type indicated by the modality information is the infrared image or the ultraviolet image, the decoder 2 is not required to acquire the color information from the bitstream BS, and even in a case where the color information is acquired from the bitstream BS, the value may be ignored.

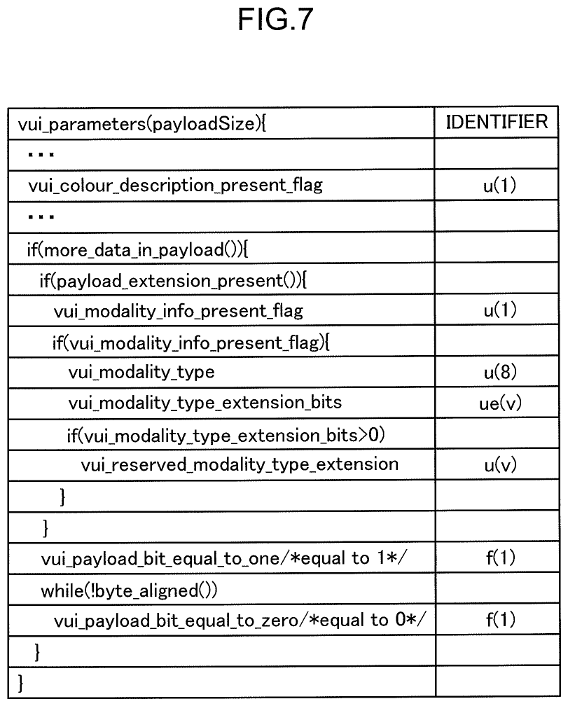

FIG. 7 is a simplified diagram showing an example of syntax of the VUI parameter including the fourth parameter P4.

The fourth parameter P4 includes extension bit information corresponding to the spare image type in a case where the modality information indicates that the image type is a spare image type for extension. The extension bit information includes information (vui_modality_type_extension_bits) indicating the bit length of the spare image type and information (vui_reserved_modality_type_extension) indicating a content of the spare image type. In a case where the value of vui_modality_type_extension_bits is 0, this indicates that the bitstream BS does not describe vui_reserved_modality_type_extension. Meanwhile, in a case where the value of vui_modality_type_extension_bits is greater than 0, this indicates that vui_reserved_modality_type_extension is described in the bitstream BS, and its bit length. The maximum value of vui_modality_type_extension_bits can be set arbitrarily, for example, to 2048.

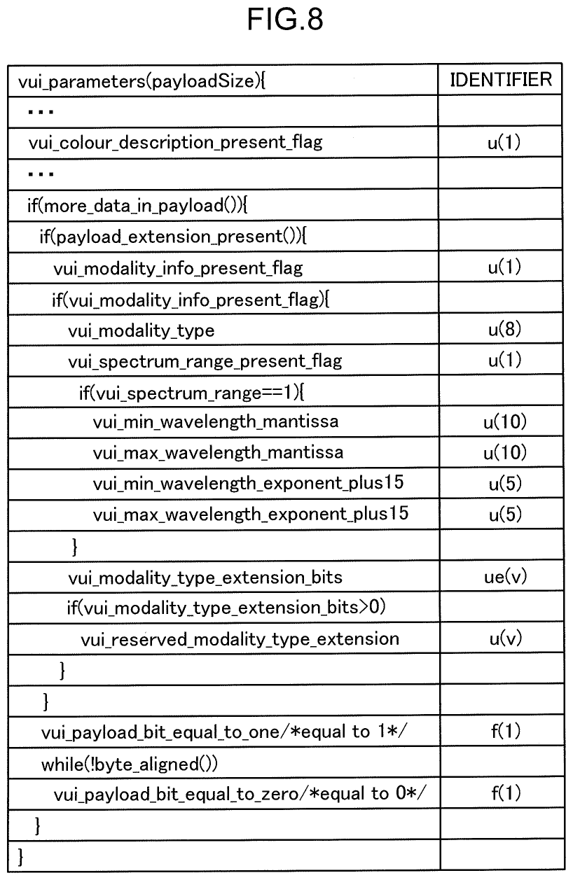

FIG. 8 is a simplified diagram showing a first example of the syntax of the VUI parameter including the second parameter P2. The second parameter P2 includes wavelength information indicating a wavelength band of light emission of the image Q.

In the example shown in FIG. 8, the second parameter P2 includes flag information (vui_spectrum_range_present_flag) indicating whether the wavelength information is described in the bitstream BS. In a case where the value of vui_spectrum_range_present_flag is 0, this indicates that the spectral band of the light emission wavelength represented in the coded layer video sequence (CLVS) image is not present in the VUI parameter. In a case where the value of vui_spectrum_range_present_flag is 1, this indicates that the spectral band of the light emission wavelength represented in the CLVS image is present in the VUI parameter.

In a case where the value of vui_spectrum_range_present_flag is 1, the wavelength information includes information indicating the minimum value (minimum wavelength) and maximum value (maximum wavelength) of the wavelength band of the image Q. Both the minimum wavelength and the maximum wavelength are in wavelengths in meters.

The information indicating the minimum value of the wavelength band includes information (vui_min_wavelength_mantissa) indicating the mantissa of the minimum value in the exponential representation using a predetermined base (for example, 10) and information (vui_min_wavelength_exponent_plus15) indicating the value obtained by adding 15 to the exponent of the minimum value. Here, in a case where vui_min_wavelength_mantissa is 0 or is not present, this means that the minimum value of the wavelength band is unknown or unspecified and the minimum value is not defined, or is defined by a method other than exponential representation. In this case, in the decoding processing, the decoder 2 is not required to acquire vui_min_wavelength_exponent_plus15 from the bitstream BS. Even in a case where vui_min_wavelength_exponent_plus15 is acquired from the bitstream BS, the value may be ignored.

The information indicating the maximum value of the wavelength band includes information (vui_max_wavelength_mantissa) indicating the mantissa of the maximum value in the exponential representation using a predetermined base (for example, 10) and information (vui_max_wavelength_exponent_plus15) indicating the value obtained by adding 15 to the exponent of the maximum value. Here, in a case where vui_max_wavelength_mantissa is 0 or is not present, this means that the maximum value of the wavelength band is unknown or unspecified and the maximum value is not defined, or is defined by a method other than exponential representation. In this case, the decoder 2 is not required to acquire vui_max_wavelength_exponent_plus15 from the bitstream BS. Even in a case where vui_max_wavelength_exponent_plus15 is acquired from the bitstream BS, the value may be ignored.

Both vui_min_wavelength_mantissa and vui_max_wavelength_mantissa have three or more significant decimal digits. In the example shown in FIG. 8, both vui_min_wavelength_mantissa and vui_max_wavelength_mantissa have a bit length of 10 bits in binary, but may have an arbitrary bit length of 11 bits or more. Similarly, in the example shown in FIG. 8, both vui_min_wavelength_exponent_plus15 and vui_max_wavelength_exponent_plus15 have a bit length of five bits in binary, but may have an arbitrary bit length of six bits or more.

Note that in the encoder 1, the minimum value of the wavelength band indicated by vui_min_wavelength_mantissa and vui_min_wavelength_exponent_plus15 is set to be equal to or greater than the shortest wavelength corresponding to the image type indicated by the modality information. Similarly, in the encoder 1, the maximum value of the wavelength band indicated by vui_max_wavelength_mantissa and vui_max_wavelength_exponent_plus15 is set to be equal to or less than the longest wavelength corresponding to the image type indicated by the modality information.

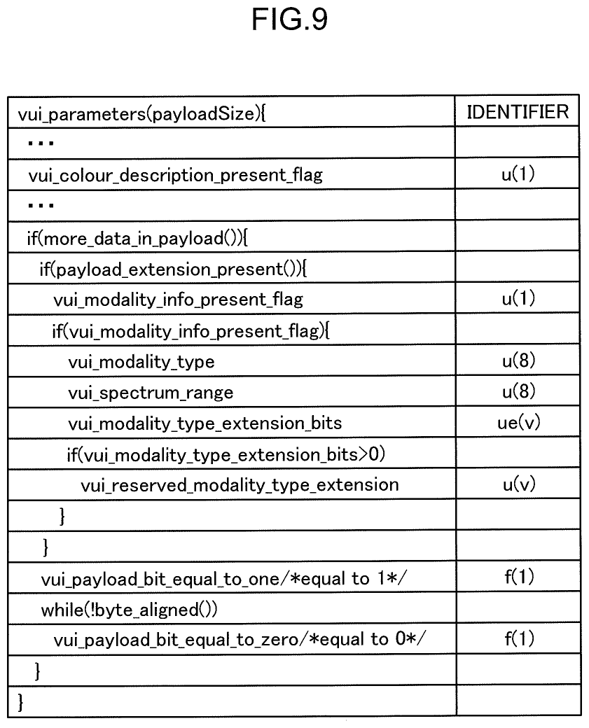

FIG. 9 is a simplified diagram showing a second example of the syntax of the VUI parameter including the second parameter P2.

In the example shown in FIG. 9, the second parameter P2 includes information indicating the index value of the wavelength information (vui_spectrum_range).

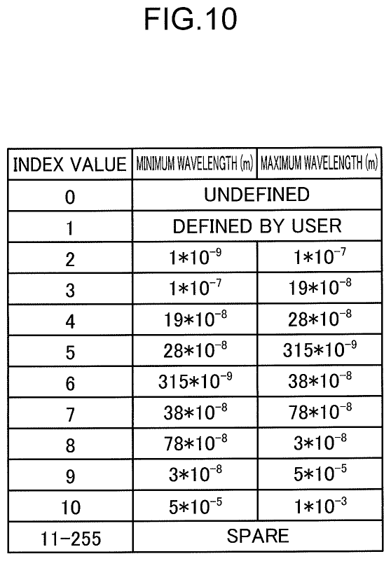

FIG. 10 is a diagram showing an example of the correspondence between the index value and the wavelength information. The minimum value (minimum wavelength) and the maximum value (maximum wavelength) of the wavelength band are defined in advance for each of the plurality of index values, and are shared by the encoder 1 and the decoder 2. In the example shown in FIG. 10, the index values 2 to 6 correspond to the ultraviolet wavelength region, the index value 7 corresponds to the visible light wavelength region, and the index values 8 to 10 correspond to the infrared wavelength region.

In a case where the index value is, for example, 2, the minimum wavelength is defined as 1*10⁻⁹ (m) and the maximum wavelength is defined as 1*10⁻⁷ (m). In a case where the index value is, for example, 3, the minimum wavelength is defined as 1*10⁻⁷ (m) and the maximum wavelength is defined as 19*10⁻⁸ (m).

In a case where the index value is a certain specific value (0 in the example shown in FIG. 10), this means that the minimum wavelength and the maximum wavelength are not defined.

In a case where the index value is another specific value (1 in the example shown in FIG. 10), this means that the minimum wavelength and the maximum wavelength are defined by user setting or the like.

Note that the index values of the other values (11-255 in this example) represent spare regions reserved for future extension use.

Note that in the encoder 1, the index value is set according to the wavelength band corresponding to the image type indicated by the modality information. For example, in a case where vui_modality_type is 1 (visible light image), vui_spectrum_range is set to any one of 0, 1, or 7. In a case where vui_modality_type is 2 (infrared image), vui_spectrum_range is set to any one of 0, 1, or 8 to 10. In a case where vui_modality_type is 3 (ultraviolet image), vui_spectrum_range is set to any one of 0, 1, or 2 to 6.

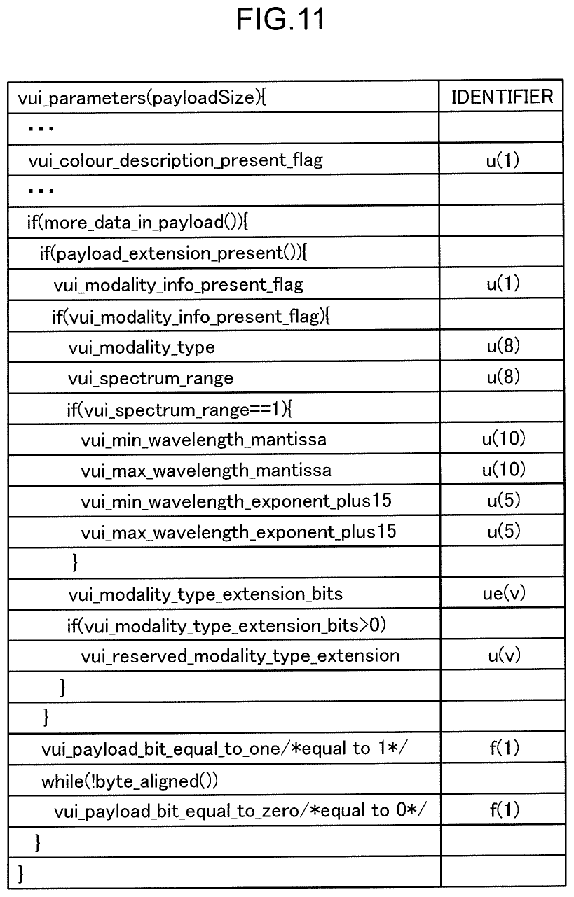

FIG. 11 is a simplified diagram showing a third example of the syntax of the VUI parameter including the second parameter P2.

In the example shown in FIG. 9, in a case where the index value of vui_spectrum_range is set to 1 (defined by user), as in the example shown in FIG. 8, the minimum value of the wavelength band may be defined by vui_min_wavelength_mantissa and vui_min_wavelength_exponent_plus15, and the maximum value of the wavelength band may be defined by vui_max_wavelength_mantissa and vui_max_wavelength_exponent_plus15.

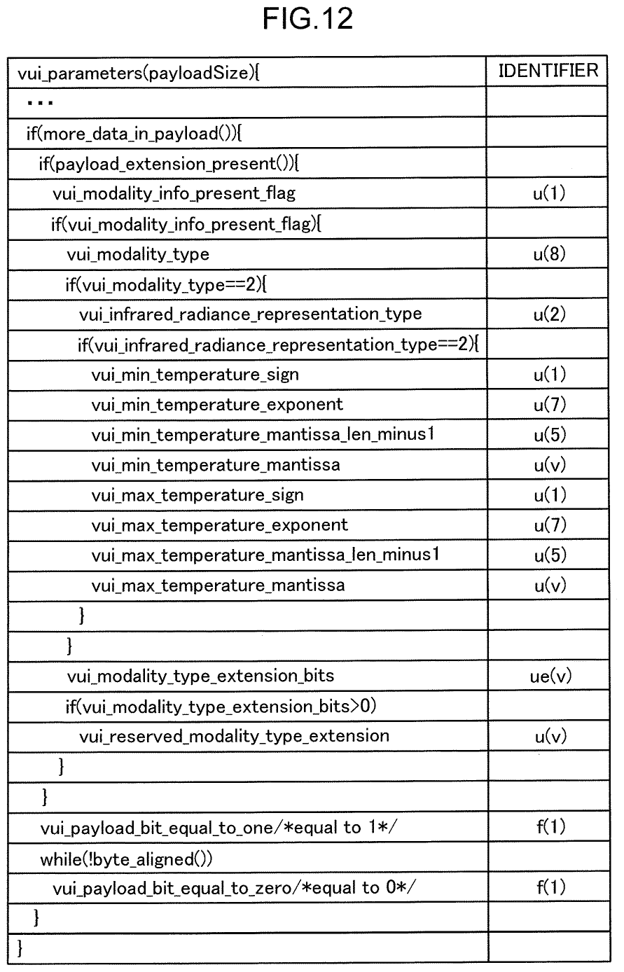

FIG. 12 is a simplified diagram showing a first modification of the syntax of the VUI parameter.

In a case where the image type indicated by the modality information is the infrared image, the encoder 1 may further encode the representation type information (vui_infrared_radiance_representation_type) indicating the representation type of the infrared radiation intensity into the bitstream BS.

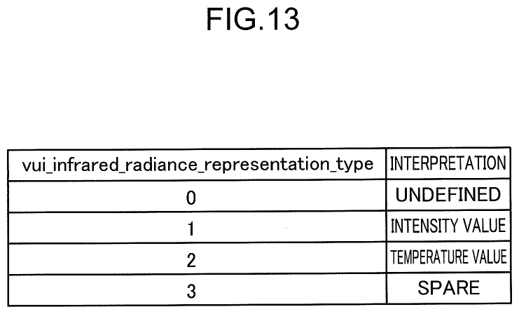

FIG. 13 is a diagram showing an example of the correspondence between values of the representation type information and the interpretation of each value.

In a case where vui_infrared_radiance_representation_type is 0 or is not present, this means that the representation type of the infrared radiation intensity is unknown or unspecified and the representation type is not defined, or this means that the representation type is defined by a method other than the intensity value representation or the temperature value representation.

In a case where the value of vui_infrared_radiance_representation_type is 1, this means that the representation type of the infrared radiation intensity is intensity value representation. In the intensity value representation, each pixel value of the image Q represents an intensity value of the infrared radiation intensity.

In a case where the value of vui_infrared_radiance_representation_type is 2, this means that the representation type of the infrared radiation intensity is temperature value representation. In the temperature value representation, each pixel value of the image Q represents the temperature value converted from the infrared radiation intensity value. vui_infrared_radiance_representation_type of any other value (3 in this example) indicates a spare region reserved for future extension use.

As shown in FIG. 12, in a case where the value of vui_infrared_radiance_representation_type is 2 (that is, temperature value representation), the encoder 1 describes the temperature information within the VUI parameter. The temperature information includes the minimum temperature value and maximum temperature value that are floating point values.

The information indicating the minimum temperature includes information indicating the positive or negative sign of the minimum temperature (vui_min_temperature_sign), information indicating the minimum temperature exponent (vui_min_temperature_exponent), information indicating a value obtained by subtracting 1 from the bit length of the mantissa of the minimum temperature (vui_min_temperature_mantissa_len_minus1), and information (vui_min_temperature_mantissa) indicating the mantissa of the minimum temperature, in exponential representation using a predetermined base (for example, 2). Note that vui_min_temperature_mantissa_len_minus1 may be omitted by setting the bit length of the mantissa of the minimum temperature to a fixed value.

In a case where the value of vui_min_temperature_sign is 0, this indicates that the sign of the minimum temperature is positive, and in a case where the value of vui_min_temperature_sign is 1, this indicates that the sign of the minimum temperature is negative.

The information indicating the maximum temperature includes information indicating the positive or negative sign of the maximum temperature (vui_max_temperature_sign), information indicating the maximum temperature exponent (vui_max_temperature_exponent), information indicating a value obtained by subtracting 1 from the bit length of the mantissa of the maximum temperature (vui_max_temperature_mantissa_len_minus1), and information (vui_max_temperature_mantissa) indicating the mantissa of the maximum temperature, in exponential representation using a predetermined base (for example, 2). Note that vui_max_temperature_mantissa_len_minus1 may be omitted by setting the bit length of the mantissa of the maximum temperature to a fixed value.

In a case where the value of vui_max_temperature_sign is 0, this indicates that the sign of the maximum temperature is positive, and in a case where the value of vui_max_temperature_sign is 1, this indicates that the sign of the maximum temperature is negative.

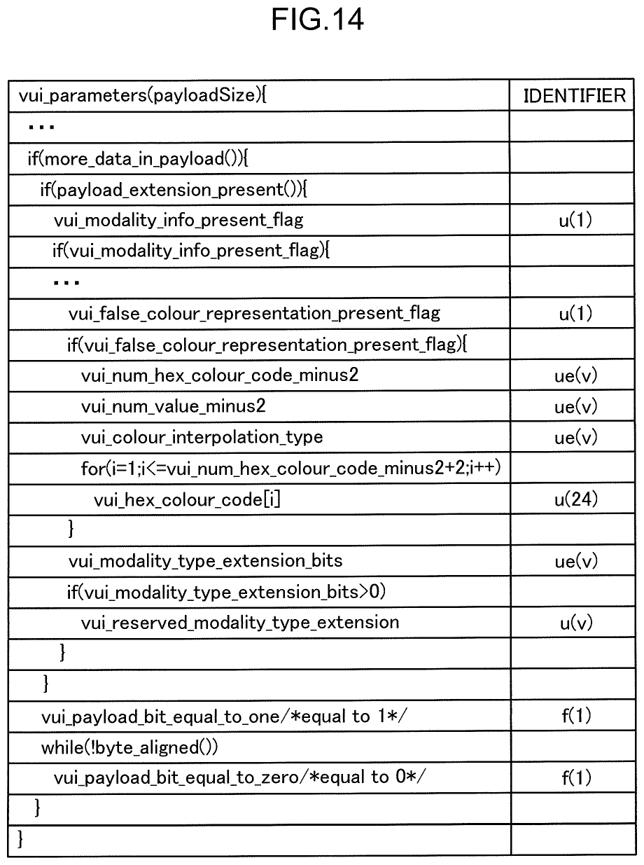

FIG. 14 is a simplified diagram showing a second modification of the syntax of the VUI parameter.

The encoder 1 may further encode, to the bitstream BS, flag information indicating whether the pixel values of the image Q are represented using the pseudo-color representation (vui_false_colour_representation_present_flag).

In a case where the value of vui_false_colour_representation_present_flag is 1, this indicates that the pixel values of the image Q are represented using the pseudo-color representation, and in a case where the value of vui_false_colour_representation_present_flag is 0, this indicates that the pixel values of the image Q are not represented using the pseudo-color representation.

In a case where the pixel values of the image Q are represented using the pseudo-color representation, generation information for generating table information that associates each pixel value of the image Q with the color code of pseudo-color representation is described within the VUI parameter.

The generation information includes information indicating the number of color codes encoded in the bitstream BS minus 2 (vui_num_hex_colour_code_minus2), information indicating a value obtained by subtracting 2 from the number of plurality of sets of pixel values and the color code (vui_num_value_minus2), interpolation information for interpolating values between the plurality of sets (vui_colour_interpolation_type), and information indicating the i-th hexadecimal color code (vui_hex_colour_code[i]). Each hexadecimal color code is 24 bits long, with the first eight bits representing depth of red, the middle eight bits representing depth of green, and the last eight bits representing depth of blue. For example, in a case where vui_hex_colour_code is 000000, this indicates black (RGB: 0,0,0), and in a case where vui_hex_colour_code is FFFFFF, this indicates white (RGB: 255, 255, 255).

In a case where the value of vui_num_hex_colour_code_minus 2 is, for example, 0, this means that the number of color codes encoded within the bitstream BS is two.

In a case where the value of vui_num_value_minus 2 is, for example, 4, this means that the number of sets of pixel values and the color code is 6. The number of sets being six means that the range of color components can be divided into five equal sections.

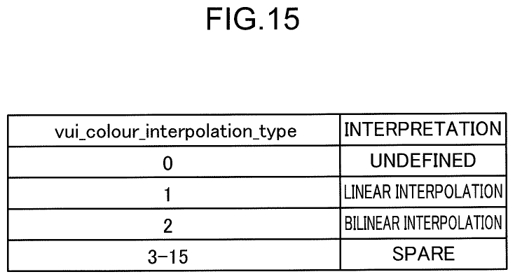

FIG. 15 is a diagram showing an example of the correspondence between values of the interpolation information and the interpretation of each value.

In a case where vui_colour_interpolation_type is 0 or is not present, this means that the interpolation type is unknown or unspecified and is not defined, or is defined by a method other than linear interpolation or bilinear interpolation.

In a case where vui_colour_interpolation_type is 1, this means that the interpolation type is linear interpolation.

In a case where vui_colour_interpolation_type is 2, this means that the interpolation type is bilinear interpolation.

Other values of vui_colour_interpolation_type (3-15 in this example) indicate a spare region reserved for future extension use.

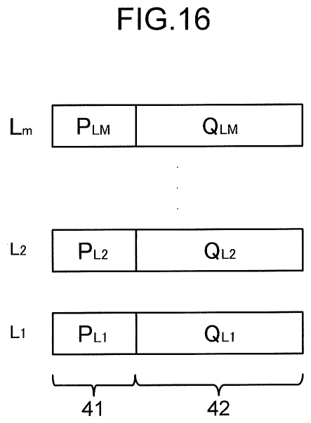

FIG. 16 is a diagram showing a configuration example of the bitstream BS.

The bitstream BS may have a multilayer configuration including image layers L₁ to Lₘ having plural m layers (m is a natural number of two or more). FIG. 16 shows only one single access unit. The access unit is a minimum processing unit of a temporal attribute, and corresponds to, for example, one frame of a moving image. The access unit is, for example, an aggregate of a plurality of NAL units corresponding to one frame of a moving image. The bitstream BS includes a plurality of temporally continuous access units.

The payload region 42 in the image layer L₁ as a first or lowermost layer stores encoded data of an image Q_{L1} as a main image. The payload region 42 in the image layer L₂ as a second layer stores encoded data of an image Q_{L2} as an auxiliary image. Similarly, the payload region 42 in an image layer Lₘ as an m-th layer stores encoded data of an image Q_{Lm} as an auxiliary image.

The images Q_{L1} to Q_{Lm} may have image types or wavelength band different from one another. For example, in a multilayer configuration including three layers with m=3, the image Q_{L1} may be a visible light image, the image Q_{L2} may be an infrared image, and an image Q_{L3} may be an ultraviolet image. The encoder 1 generates the bitstream BS having the multilayer configuration by encoding an output signal from a multispectral camera.

In a case where the images Q_{L1} to Q_{Lm} have correlation therebetween, image reference may be made among the image layers L₁ to Lₘ. On the other hand, in a case where the images Q_{L1} to Q_{Lm} have no correlation therebetween, image reference is not required to be made among the image layers L₁ to Lₘ.

The header region 41 in the image layer L₁ stores encoded data of the parameter P_{L1} associated with the image Q_{L1}. The parameter P_{L1} includes the modality information and the wavelength information on the image Q_{L1}.

The header region 41 in the image layer L₂ stores encoded data of the parameter P_{L2} associated with the image Q_{L2}. The parameter P_{L2} includes the modality information and the wavelength information on the image Q_{L2}.

The header region 41 in the image layer Lₘ stores encoded data of the parameter P_{Lm} associated with the image Q_{Lm}. The parameter P_{Lm} includes the modality information and the wavelength information on the image Q_{Lm}.

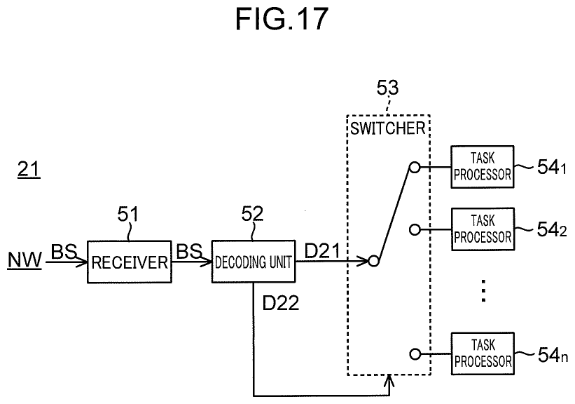

FIG. 17 is a simplified diagram showing a configuration of the circuitry 21 included in the decoder 2. The circuitry 21 includes a receiver 51, a decoding unit 52, a switcher 53, and plural n (n is a natural number of two or more) of task processors 54₁ to 54ₙ. Task processing executed by the task processors 54₁ to 54ₙ includes the human vision and the machine task. The machine task includes various types of task processing with use of an AI model, such as object detection, object tracking, object segmentation, action recognition, or pose estimation.

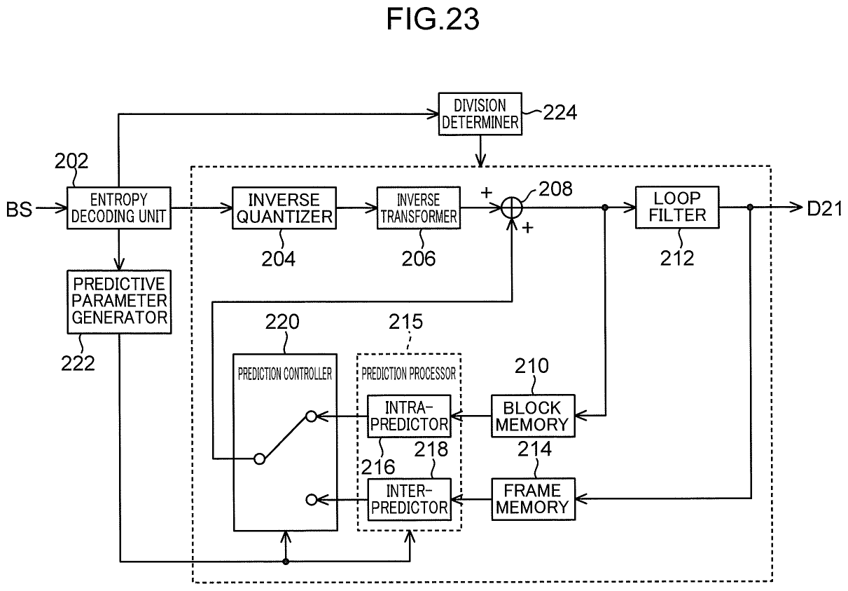

Next, description will be made on the decoding unit 52 according to the present embodiment. FIG. 23 is a block diagram showing an example of a functional configuration of the decoding unit 52 according to the present embodiment. The decoding unit 52 decodes a stream as an encoded image in block units.

As shown in FIG. 23, the decoding unit 52 includes an entropy decoding unit 202, an inverse quantizer 204, an inverse transformer 206, an adder 208, a block memory 210, a loop filter 212, a frame memory 214, an intra-predictor 216, an inter-predictor 218, a prediction controller 220, a predictive parameter generator 222, and a division determiner 224. Note that the intra-predictor 216 and the inter-predictor 218 constitute part of a prediction processor 215.

For example, the decoding unit 52 shown in FIG. 23 includes a plurality of constituent elements implemented by the circuitry 21 and the memory 22 shown in FIG. 1.

The circuitry 21 includes a processor such as a CPU. The circuitry 21 may be constituted by an electronic circuitry dedicated or generalized to stream decoding, or by an assembly of a plurality of electronic circuitrys. For example, the circuitry 21 may function as a plurality of constituent elements except for a constituent element for information storage, out of the plurality of constituent elements included in the decoding unit 52 shown in FIG. 23.

The memory 22 may be a dedicated or generalized electronic circuitry to store information, or an assembly of a plurality of electronic circuitrys. The memory 22 may be externally connected to the circuitry 21 or may be incorporated in the circuitry 21. The memory 22 may be a magnetic disk, an optical disk, or the like, or may be expressed as a storage, a recording medium, or the like. The memory 22 may be a nonvolatile memory or a volatile memory.

The memory 22 may store a stream to be decoded or a decoded image. The memory 22 may store a program for stream decoding processing by a processor.

The memory 22 may function as the constituent element for information storage, out of the plurality of constituent elements included in the decoding unit 52 shown in FIG. 23. Specifically, the memory 22 may function as the block memory 210 and the frame memory 214 shown in FIG. 23. More specifically, the memory 22 may store a reconstructed image (specifically, a reconstructed block, a reconstructed picture, or the like).

Note that in the decoding unit 52, part of the plurality of constituent elements shown in FIG. 23 is not required to be mounted, and part of a plurality of processing executed by the plurality of constituent elements is not required to be executed. Alternatively, part of the plurality of constituent elements shown in FIG. 23 may be mounted on a different device, and part of the plurality of processing executed by the plurality of constituent elements may be executed by the different device.

Each of the inverse quantizer 204, the inverse transformer 206, the adder 208, the block memory 210, the frame memory 214, the intra-predictor 216, the inter-predictor 218, the prediction controller 220, and the loop filter 212 included in the decoding unit 52 shown in FIG. 23 executes processing similarly to each of the inverse quantizer 112, the inverse transformer 114, the adder 116, the block memory 118, the frame memory 122, the intra-predictor 124, the inter-predictor 126, the prediction controller 128, and the loop filter 120 included in the encoding unit 33 shown in FIG. 21.

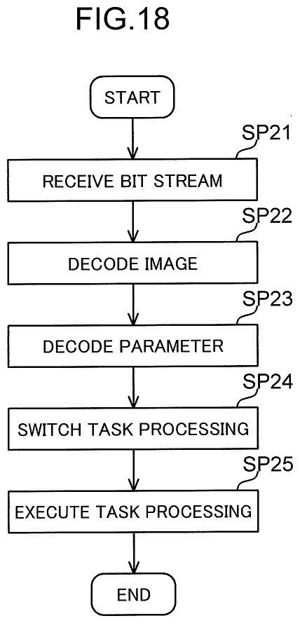

FIG. 18 is a flowchart showing processing executed by the circuitry 21 included in the decoder 2.

First, in step SP21, the receiver 51 receives the bitstream BS transmitted from the encoder 1 via the transmission path NW.

Next, in step SP22, the decoding unit 52 acquires the image Q through decoding from the payload region 42 in the bitstream BS received from the receiver 51. Note that decoding may include extraction. The decoding unit 52 outputs image data D21 of the image Q. The image data D21 corresponds to the image data D11 indicated in FIG. 2.

As shown in FIG. 16, in a case where the bitstream BS has a multilayer configuration including a plurality of image layers L₁ to Lₘ, the decoding unit 52 may acquire the plurality of images Q_{L1} to Q_{Lm} different in terms of image type or wavelength band from the plurality of image layers L₁ to Lₘ.

Next, in step SP23, the decoding unit 52 acquires the parameter P through decoding from the header region 41 (or the predetermined region 43 in the header region 41) in the bitstream BS received from the receiver 51. As described above, the parameter P includes the first parameter P1, the second parameter P2, the third parameter P3, and the fourth parameter P4. The first parameter P1 includes modality information indicating an image type of the image Q. The second parameter P2 includes wavelength information indicating a wavelength band of light emission of the image Q. The third parameter P3 includes color information of the image Q. The fourth parameter P4 includes extension bit information corresponding to a spare image type in a case where the modality information indicates that the image type is a spare image type for extension. Processing in step SP22 and processing in step SP23 may be executed in inverse order of exemplification in FIG. 18, or may be executed simultaneously.

In a case where the VUI parameter shown in FIG. 12 is included in the parameter P, and in a case where the modality information indicates that the image type is an infrared image (that is, in a case where the value of vui_modality_type is 2), the decoding unit 52 further acquires the representation type information indicating the representation type of the infrared radiation intensity from the bitstream BS. In a case where the representation type information indicates that the pixel value represents a temperature value (that is, in a case where it is a temperature value representation), the decoding unit 52 further acquires temperature information including the minimum and maximum temperatures of the temperature value from the bitstream BS.

In a case where the VUI parameter shown in FIG. 14 is included in the parameter P and the flag information indicates that the pixel values are represented using pseudo-color representation (that is, in a case where the value of vui_false_colour_representation_present_flag is 1), the decoding unit 52 further acquires, from the bitstream BS, the above-mentioned generation information for generating table information that associates each pixel value of the image Q with a color code of pseudo-color representation. The decoding unit 52 generates the table information on the basis of the acquired generation information.

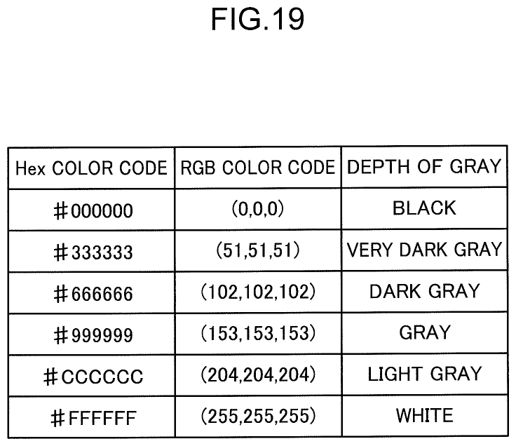

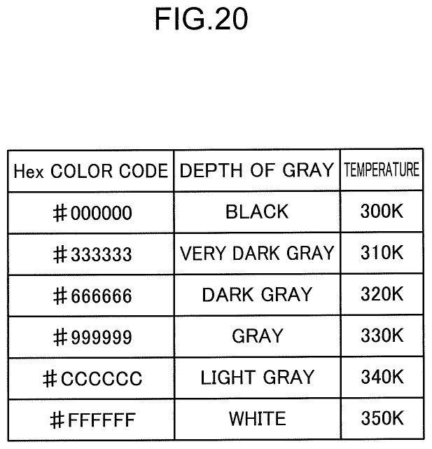

FIGS. 19 and 20 are simplified diagrams showing an example of the table information.

In the example shown in FIGS. 19 and 20, the number of sets of pixel values and color codes is six (that is, the value of vui_num_value_minus 2 is 4), and the image type is an infrared image. The interpolation type can be linear interpolation or bilinear interpolation.

In the example shown in FIG. 19, the table information indicates the correspondence between hexadecimal color codes (Hex color codes), RGB color codes, and depth of gray.

In the example shown in FIG. 20, the table information indicates the correspondence between the Hex color codes, depth of gray, and temperature, where the depth of gray is mapped to the temperature. For example, black represents a temperature of 300K, gray represents a temperature of 330K, and white represents a temperature of 350K.

Next, in step SP24, the switcher 53 switches the task processors 54₁ to 54ₙ on the basis of the modality information received from the decoding unit 52. The switcher 53 retains the table information (not shown) including preliminarily set correspondence between the plurality of image types and the plurality of task processors 54₁ to 54ₙ. The switcher 53 refers to the table information to select one of the plurality of task processors 54₁ to 54ₙ corresponding to the image type indicated by the modality information.

With reference to FIG. 18, next, in step SP25, the one of the task processors 54₁ to 54ₙ thus selected in step SP24 executes task processing on the basis of the image data D21 received from the decoding unit 52 via the switcher 53.

The encoder 1 and the decoder 2 according to the present embodiment can transmit, from the encoder 1 to the decoder 2, the modality information indicating the image type of the image Q and the wavelength information indicating the wavelength band of light emission of the image Q included in the bitstream BS, thereby making it possible to improve execution accuracy of task processing by the decoder 2.

In the encoder 1 and the decoder 2 according to the present embodiment, the modality information indicates that the image type is at least one of the visible light image, the infrared image, the ultraviolet image, an undefined image type, and the spare image type for extension. Therefore, there is included the modality information indicating that the image type is not defined or that the image type is a spare image type for extension. Therefore, it is possible to handle a case where the image characteristics are unknown and the image type cannot be identified in the encoder 1, or to extend image types in the future.

### Developed Model of Present Disclosure

The encoder 1 and the decoder 2 according to the above embodiment are devices compatible with versatile video coding (VVC) (H.266) which is a next-generation video coding standard. In VVC, it has been studied to extend and include image-related information such as modality information in VUI parameters. However, in advanced video coding (AVC) (H.264) or high efficiency video coding (HEVC) (H.265) which is an existing video coding standard, the VUI parameter cannot be directly extended. Therefore, in a case where the encoder 1 and the decoder 2 are compatible with AVC or HEVC, it is not possible to appropriately process image-related information such as modality information extended to the VUI parameter. In this developed model, syntax of sequence parameter set (SPS) is appropriately hierarchized by using extension flag information, and the encoder 1 and the decoder 2 that cannot directly extend the VUI parameter can also appropriately process the image-related information such as the modality information. Note that not only the SPS but also VUI, VPS, SPS, PPS, PH, SH, APS, SEI, a tile header, a system layer header, or the like may be used.

As in the configuration shown in FIG. 1, the encoder 1 according to this developed model includes circuitry 11 and a memory 12 connected to the circuitry 11. The decoder 2 includes circuitry 21 and a memory 22 connected to the circuitry 21.

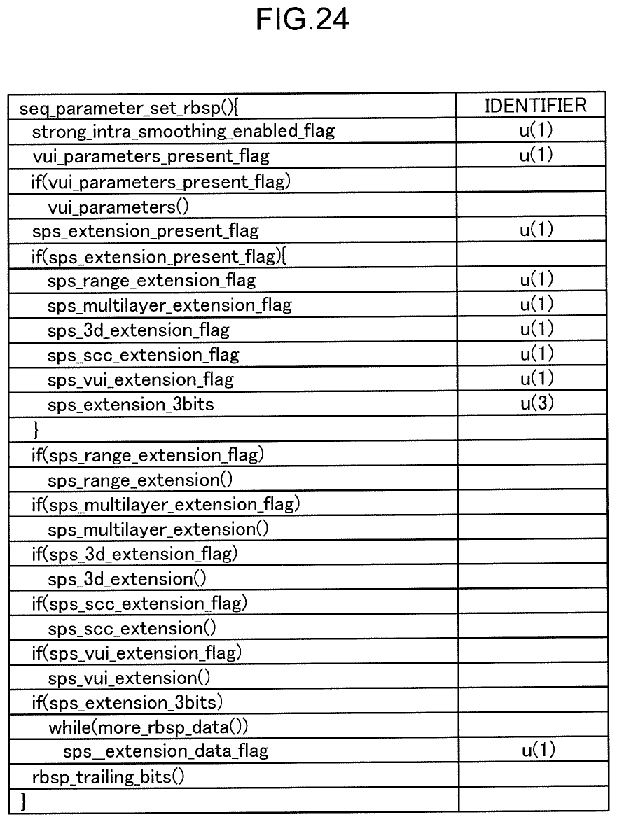

FIG. 24 is a simplified diagram showing a first example of the syntax of SPS in HEVC.

A network abstraction layer (NAL) unit of the SPS includes first presence flag information (vui_parameters_present_flag), first video usability information (vui_parameters()), first extension flag information (sps_vui_extension_flag), second video usability information (sps_vui_extension( )), second extension flag information (sps_extension_3 bits), and first extension information (sps_extension_data_flag).

The first presence flag information indicates whether the first video usability information is described in the bitstream BS. In a case where the first presence flag information is a true value (1), it is indicated that the first video usability information is described in the bitstream BS; in a case where the first presence flag information is a false value (0), it is indicated that the first video usability information is not described in the bitstream BS.

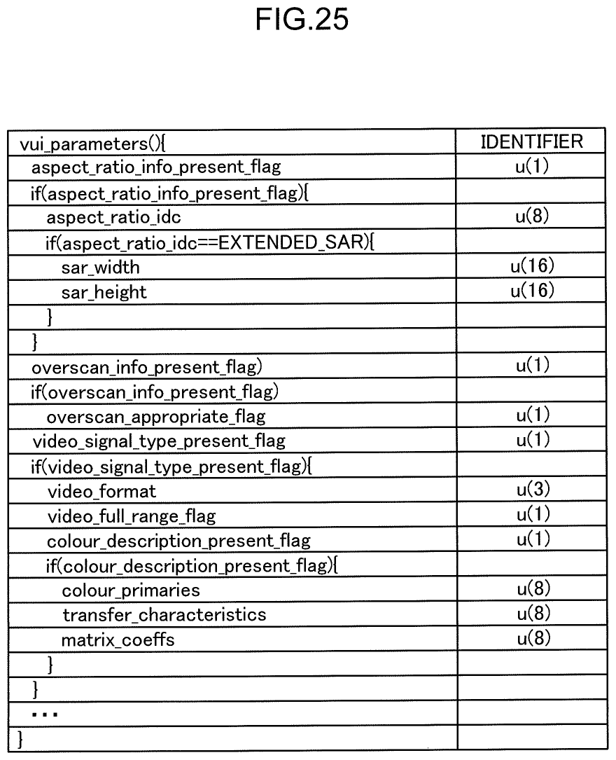

FIG. 25 is a simplified diagram showing an example of syntax of the first video usability information in HEVC or advanced video coding (AVC). The first video usability information is a VUI parameter including information regarding an aspect ratio of an image included in the bitstream BS (sar_width, sar_height), a part of color information of the image (colour_primaries, transfer_characteristics, matrix_coeffs), and the like.

Referring to FIG. 24, the first extension flag information indicates whether the second video usability information extending the video usability information is described in the bitstream BS. In a case where the first extension flag information is a true value (1), it is indicated that the second video usability information is described in the bitstream BS; in a case where the first extension flag information is a false value (0), it is indicated that the second video usability information is not described in the bitstream BS.

The second video usability information includes related information (image-related information) related to an image included in the bitstream BS, such as modality information. Details of the second video usability information will be described later.

The second extension flag information indicates a spare region reserved for future extension use. The second extension flag information indicates whether the first extension information extending other information of an NAL unit in which the second video usability information is described is described in the bitstream BS. In a case where the second extension flag information is a true value (1), it is indicated that the first extension information is described in the bitstream BS, and in a case where the second extension flag information is a false value (0) or the second extension flag information is not present, it indicates that the first extension information is not described in the bitstream BS. In a case where the first extension information is included in a tail end of an NAL unit storing the first extension information, the first extension information has a bit string continuous up to a terminal bit of the NAL unit.

In a case where the encoder 1 corresponds to HEVC or AVC but does not correspond to the second video usability information, the encoding unit 33 encodes the first extension flag information that is a false value (0) into the bitstream BS, and does not encode the second video usability information, the second extension flag information, and the first extension information into the bitstream BS.

In a case where the decoder 2 corresponds to HEVC or AVC but does not support the second video usability information, in a case where the first extension flag information is a true value (1), the decoding unit 52 ignores the second video usability information, the second extension flag information, and the first extension information in the decoding processing. Ignoring in the decoding processing includes not decoding or includes discarding a decoded result.

In a case where the encoder 1 corresponds to the second video usability information but cannot interpret the first extension information, the encoding unit 33 encodes the first extension flag information that is a true value (1), the second extension flag information that is a false value (0), and the second video usability information into the bitstream BS, and does not encode the first extension information into the bitstream BS.

In a case where the decoder 2 corresponds to the second video usability information but cannot interpret the first extension information, in a case where the first extension flag information is a true value (1), the decoding unit 52 decodes the second video usability information and the second extension flag information from the bitstream BS, and in a case where the second extension flag information is a true value (1), the decoding unit ignores the first extension information in the decoding processing.

As shown in FIGS. 2 and 3, the setting unit 32 sets the parameter P such as the SPS in step SP12, and the encoding unit 33 encodes the parameter P into the bitstream BS in step SP14. As shown in FIGS. 17 and 18, the decoding unit 52 decodes the parameter P from the bitstream BS in step SP23.

Here, the encoding unit 33 encodes the first presence flag information into the bitstream BS. The encoding unit 33 encodes the first video usability information into the bitstream BS in a case where the first presence flag information is a true value (1), and the encoding unit 33 does not encode the first video usability information into the bitstream BS in a case where the first presence flag information is a false value (0). The decoding unit 52 decodes the first presence flag information from the bitstream BS. The decoding unit 52 decodes the first video usability information from the bitstream BS in a case where the first presence flag information is a true value (1), and the decoding unit 52 does not decode the first video usability information from the bitstream BS in a case where the first presence flag information is a false value (0).

The encoding unit 33 encodes the first extension flag information into the bitstream BS. The encoding unit 33 encodes the second video usability information into the bitstream BS in a case where the first extension flag information is a true value (1), and the encoding unit 33 does not encode the second video usability information into the bitstream BS in a case where the first extension flag information is a false value (0). The decoding unit 52 decodes the first extension flag information from the bitstream BS. The decoding unit 52 decodes the second video usability information from the bitstream BS in a case where the first extension flag information is a true value (1), and the decoding unit 52 does not decode the second video usability information from the bitstream BS in a case where the first extension flag information is a false value (0).

The encoding unit 33 encodes the second extension flag information into the bitstream BS. The encoding unit 33 encodes the first extension information into the bitstream BS in a case where the second extension flag information is a true value (1), and the encoding unit 33 does not encode the first extension information into the bitstream BS in a case where the second extension flag information is a false value (0). The decoding unit 52 decodes the second extension flag information from the bitstream BS. The decoding unit 52 decodes the first extension information from the bitstream BS in a case where the second extension flag information is a true value (1), and the decoding unit 52 does not decode the first extension information from the bitstream BS in a case where the second extension flag information is a false value (0).

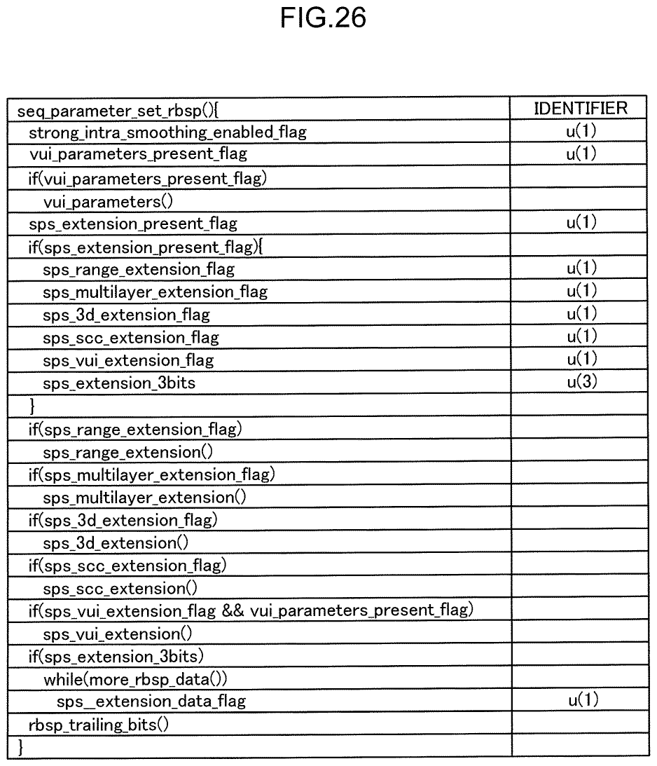

FIG. 26 is a simplified diagram showing a second example of the syntax of SPS in HEVC.

In a case where the first extension flag information is a true value (1) and the first presence flag information is a true value (1), the encoding unit 33 encodes the second video usability information into the bitstream BS. In a case where the first extension flag information is a true value (1) and the first presence flag information is a true value (1), the decoding unit 52 decodes the second video usability information from the bitstream BS. As a result, it is possible to prevent inconsistent processing of encoding and decoding only the second video usability information without encoding and decoding the first video usability information.

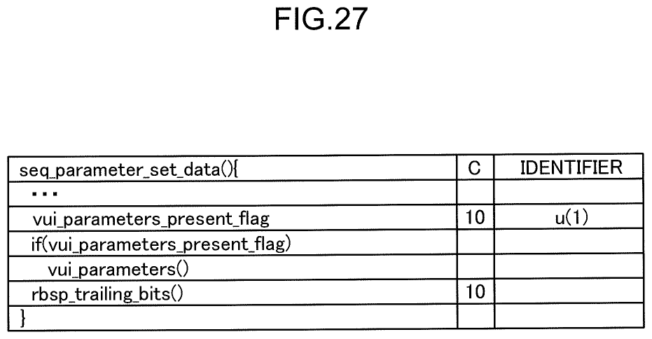

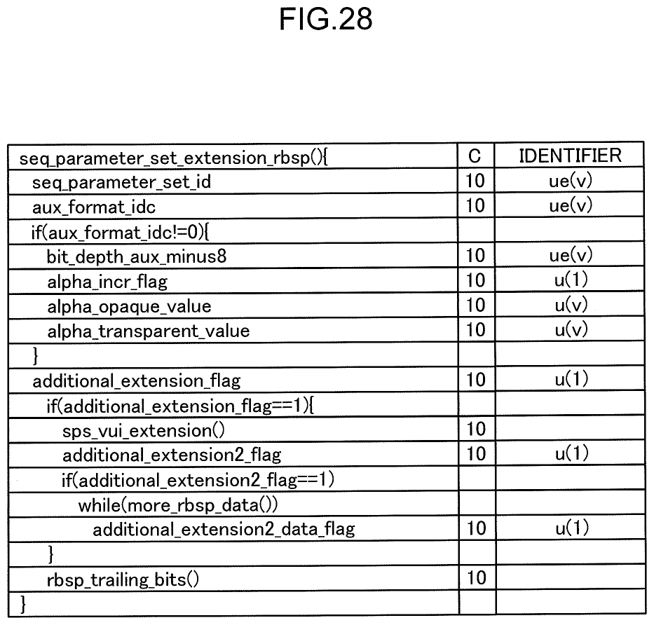

FIGS. 27 and 28 are simplified diagrams showing a first example of the syntax of SPS in AVC.

As shown in FIG. 27, a first NAL unit of the SPS includes first presence flag information (vui_parameters_present_flag) and the first video usability information (vui_parameters( )). As shown in FIG. 28, a second NAL unit of the SPS includes first extension flag information (additional_extension_flag), second video usability information (sps_vui_extension( )), second extension flag information (additional_extension2_flag), and first extension information (additional_extension2_data_flag).

The encoding unit 33 encodes the first presence flag information and the first video usability information into the first NAL unit. The encoding unit 33 encodes the first extension flag information, the second video usability information, the second extension flag information, and the first extension information into the second NAL unit. The decoding unit 52 decodes the first presence flag information and the first video usability information from the first NAL unit. The decoding unit 52 decodes the first extension flag information, the second video usability information, the second extension flag information, and the first extension information from the second NAL unit.

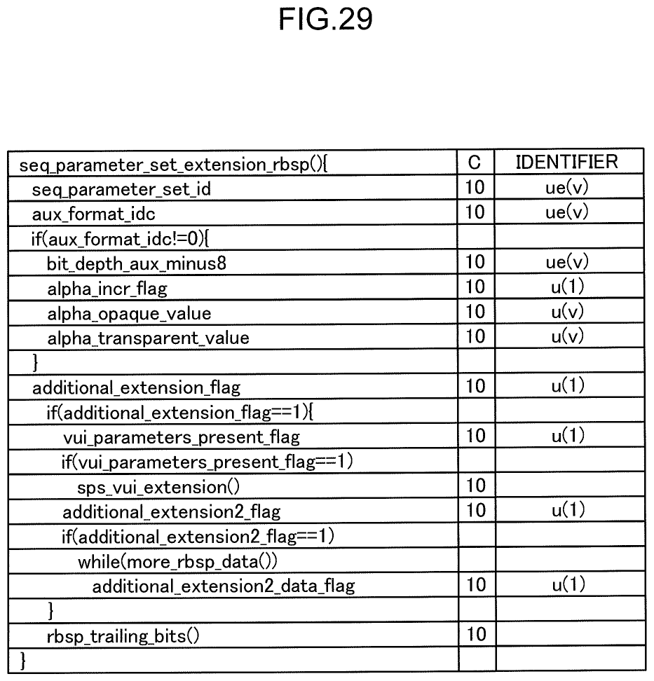

FIG. 29 is a simplified diagram showing a second example of the syntax of SPS in AVC. The syntax of the first NAL unit is similar to the syntax in FIG. 27. As shown in FIG. 29, the second NAL unit further includes second presence flag information (vui_parameters_present_flag) in addition to the first extension flag information, the second video usability information, the second extension flag information, and the first extension information similar to those in FIG. 28. Similarly to the first presence flag information, the second presence flag information indicates whether the first video usability information is described in the bitstream BS. In a case where the second presence flag information is a true value (1), it is indicated that the first video usability information is described in the bitstream BS; in a case where the second presence flag information is a false value (0), it is indicated that the first video usability information is not described in the bitstream BS.

In a case where the second extension flag information is a true value (1) and the first presence flag information is a true value (1), the encoding unit 33 encodes the second video usability information into the bitstream BS. In a case where the second extension flag information is a true value (1) and the first presence flag information is a true value (1), the decoding unit 52 decodes the second video usability information from the bitstream BS. As a result, it is possible to prevent inconsistent processing of encoding and decoding only the second video usability information without encoding and decoding the first video usability information.

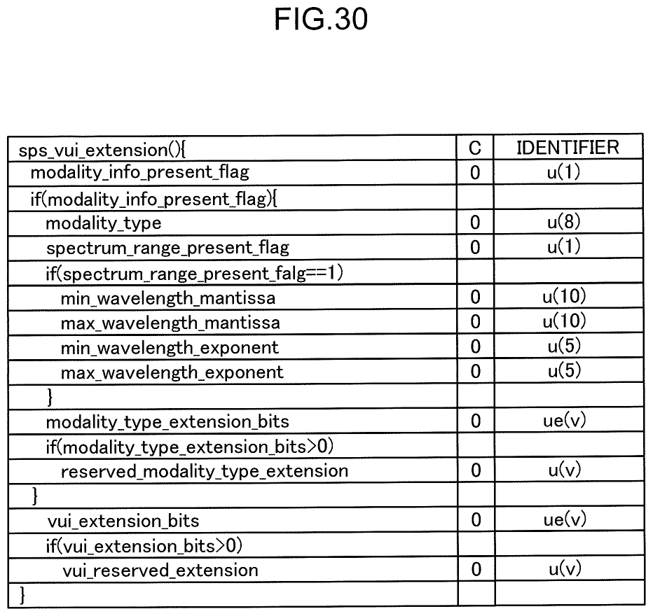

FIG. 30 is a simplified diagram showing a first example of the syntax of the second video usability information in HEVC or AVC.

The second video usability information includes image-related information, first size information (modality_type_extension_bits), extension modality information (reserved_modality_type_extension), second size information (vui_extension_bits), and second extension information (vui_reserved_extension).

The image-related information includes modality information (modality_type), wavelength information (min_wavelength_mantissa, max_wavelength_mantissa, min_wavelength_exponent, max_wavelength_exponent), and the like. However, the image-related information is not limited to the modality information, the wavelength information, and the like, and may be arbitrary information related to an image included in the bitstream BS. For example, the image-related information may be phase information notified from an encoder to a decoder in order to avoid a display position shift in an encoding technique (RPR) in which an image reduced on an encoder side is enlarged and displayed on a decoder side. The phase information may be individually set in each of a horizontal direction and a vertical direction of the image.

The first size information indicates the size (bit count in this example) of the extension modality information. The extension modality information extends the modality information. The second size information indicates the size (bit count in this example) of the second extension information. The second extension information further extends the second video usability information.

The first size information greater than 0 bits indicates that the extension modality information is present in the second video usability information and indicates the bit count of the extension modality information. In a case where the first size information is 0, it is indicated that the extension modality information is not present in the second video usability information. The value of the first size information ranges from 0 to, for example, 2048.

Similarly, the second size information greater than 0 bits indicates that the second extension information is present in the second video usability information and indicates the bit count of the second extension information. In a case where the second size information is 0, it is indicated that the second extension information is not present in the second video usability information. The value of the second size information ranges from 0 to, for example, 2048.

The encoding unit 33 encodes the image-related information related to the image included in the bitstream BS into the second video usability information.

In a case of setting the extension modality information, the encoding unit 33 encodes the first size information indicating the size of the extension modality information into the second video usability information, and encodes the extension modality information into the second video usability information on the basis of the first size information. The decoding unit 52 decodes the first size information from the second video usability information, and decodes the extension modality information from the second video usability information on the basis of the first size information.

On the other hand, in a case where the extension modality information is not set, or in a case where the extension modality information cannot be interpreted, the encoding unit 33 encodes the 0-bit first size information into the second video usability information, and does not encode the extension modality information into the second video usability information. In a case of decoding the 0-bit first size information from the second video usability information, the decoding unit 52 does not decode the extension modality information from the second video usability information.

In a case of setting the second extension information, the encoding unit 33 encodes the second size information indicating the size of the second extension information into the second video usability information, and encodes the second extension information into the second video usability information on the basis of the second size information. The decoding unit 52 decodes the second size information from the second video usability information, and decodes the second extension information from the second video usability information on the basis of the second size information.

On the other hand, in a case where the second extension information is not set, or in a case where the second extension information cannot be interpreted, the encoding unit 33 encodes the 0-bit second size information into the second video usability information, and does not encode the second extension information into the second video usability information. In a case of decoding the 0-bit second size information from the second video usability information, the decoding unit 52 does not decode the second extension information from the second video usability information. As a result, in a case where information is further added to the second video usability information by future standard update, the information regarding the modality is described in the bitstream as the extension modality information, and the other information regarding the video usability is described in the bitstream as the second extension information, and thus, appropriate encoding and decoding can be performed. On the other hand, even in a case where information is further added to the second video usability information by a future standard update, even if the extension modality information and the second extension information are described in the bitstream, the existing decoder that does not support the future standard update can decode the bitstream without inconsistency by ignoring the information.

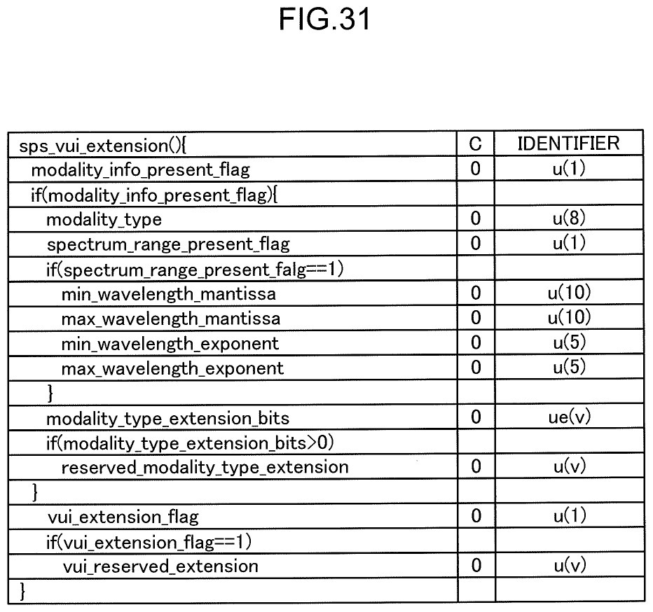

FIG. 31 is a simplified diagram showing a second example of the syntax of the second video usability information in HEVC or AVC.

The second video usability information includes third extension flag information (vui_extension_flag) instead of the second size information shown in FIG. 30. In a case where the third extension flag information is a true value (1), it is indicated that the second extension information is described in the bitstream BS, and in a case where the third extension flag information is a false value (0) or the third extension flag information is not present, it indicates that the second extension information is not described in the bitstream BS.

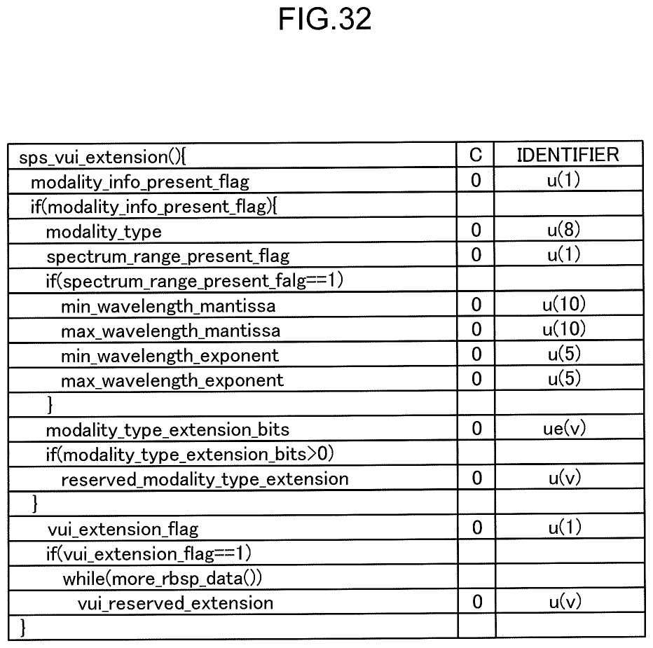

FIG. 32 is a simplified diagram showing a third example of the syntax of the second video usability information in HEVC or AVC.

Similar to the second example shown in FIG. 31, the second video usability information includes third extension flag information (vui_extension_flag). In a case where the third extension flag information is a true value (1), it is indicated that the second extension information is described in the bitstream BS, and in a case where the third extension flag information is a false value (0) or the third extension flag information is not present, it indicates that the second extension information is not described in the bitstream BS. In a case where the second extension information is included in a tail end of an NAL unit storing the second extension information, the second extension information has a bit string continuous up to a terminal bit of the NAL unit.

In the encoder 1 and the decoder 2 of this developed model, video usability information can be appropriately extended by the first extension flag information and the second video usability information. The extension flag information can be appropriately extended by the second extension flag information and the first extension information.

The present disclosure is particularly useful for application to an image processing system including an encoder that encodes an image into a bitstream and transmits the bitstream, and a decoder that decodes an image from a received bitstream.

1. A decoder comprising:
circuitry; and
a memory connected to the circuitry,
wherein the circuitry, in operation:
acquires, from a bitstream, first presence flag information indicating whether first video usability information is described in the bitstream,
in a case the first presence flag information is a true value, acquires the first video usability information from the bitstream,
acquires, from the bitstream, first extension flag information indicating whether second video usability information is described in the bitstream,
in a case the first extension flag information is a true value, acquires the second video usability information from the bitstream,
acquires, from the bitstream, second extension flag information indicating whether first extension information is described in the bitstream, the first extension information extending other information of a network abstraction layer (NAL) unit in which the second video usability information is described, and
in a case the second extension flag information is a true value, acquires the first extension information from the bitstream.

2. The decoder according to claim 1, wherein
the circuitry, in operation, acquires the first presence flag information, the first video usability information, the first extension flag information, the second video usability information, the second extension flag information, and the first extension information from a same NAL unit.

3. The decoder according to claim 2, wherein
the circuitry, in operation, acquires the second video usability information from the NAL unit in a case where the first extension flag information is a true value and the first presence flag information is a true value.

4. The decoder according to claim 1, wherein
the circuitry, in operation:
acquires the first presence flag information and the first video usability information from a first NAL unit, and
acquires the first extension flag information, the second video usability information, the second extension flag information, and the first extension information from a second NAL unit.

5. The decoder according to claim 4, wherein
the circuitry, in operation, acquires, from the second NAL unit, second presence flag information indicating whether the first video usability information is described in the bitstream, and
in a case the first extension flag information is a true value and the second presence flag information is a true value, the circuitry acquires the second video usability information from the second NAL unit.

6. The decoder according to claim 1, wherein
the circuitry, in operation:
acquires image-related information related to an image included in the bitstream from the second video usability information, and
in a case second extension information that further extends the second video usability information is described in the second video usability information, the circuitry acquires, from the second video usability information, size information indicating a size of the second extension information, and
acquires the second extension information from the second video usability information on a basis of the size information.

7. The decoder according to claim 1, wherein
the circuitry, in operation:
acquires image-related information related to an image included in the bitstream from the second video usability information,
acquires, from the second video usability information, third extension flag information indicating whether second extension information that further extends the second video usability information is described in the second video usability information, and
in a case the third extension flag information is a true value, the circuitry acquires the second extension information from the second video usability information.

8. The decoder according to claim 1, wherein
the first extension information includes a bit string continuous up to a terminal bit of an NAL unit that stores the first extension information.

9. The decoder according to claim 7, wherein
the second extension information includes a bit string continuous up to a terminal bit of an NAL unit that stores the second extension information.

10. The decoder according to claim 1, wherein
the second video usability information includes image-related information related to an image included in the bitstream, and
in a case the first extension flag information is a true value in the decoder that does not allow interpretation of the image-related information, the circuitry, in operation, ignores the second video usability information, the second extension flag information, and the first extension information.

11. The decoder according to claim 1, wherein
the second video usability information includes image-related information related to an image included in the bitstream,
in the decoder that allows interpretation of the image-related information but does not allow interpretation of the first extension information, in a case the first extension flag information is a true value,
the circuitry, in operation, acquires the second video usability information and the second extension flag information from the bitstream, and
in a case the second extension flag information is a true value, the circuitry, in operation, ignores the first extension information.

12. An encoder comprising:
circuitry; and
a memory connected to the circuitry,
wherein the circuitry, in operation:
encodes, into a bitstream, first presence flag information indicating whether first video usability information is described in the bitstream,
in a case the first presence flag information is a true value, encodes the first video usability information into the bitstream,
encodes, into the bitstream, first extension flag information indicating whether second video usability information is described in the bitstream,
in a case the first extension flag information is a true value, encodes the second video usability information into the bitstream,
encodes, into the bitstream, second extension flag information indicating whether first extension information is described in the bitstream, the first extension information extending other information of a network abstraction layer (NAL) unit in which the second video usability information is described, and
in a case the second extension flag information is a true value, encodes the first extension information into the bitstream.

13. The encoder according to claim 12, wherein
the circuitry, in operation, encodes the first presence flag information, the first video usability information, the first extension flag information, the second video usability information, the second extension flag information, and the first extension information into a same NAL unit.

14. The encoder according to claim 13, wherein
the circuitry, in operation, encodes the second video usability information into the NAL unit in a case where the first extension flag information is a true value and the first presence flag information is a true value.

15. The encoder according to claim 12, wherein
the circuitry, in operation:
encodes the first presence flag information and the first video usability information into a first NAL unit, and
encodes the first extension flag information, the second video usability information, the second extension flag information, and the first extension information into a second NAL unit.

16. The encoder according to claim 15, wherein
the circuitry, in operation, encodes, into the second NAL unit, second presence flag information indicating whether the first video usability information is described in the bitstream, and
in a case the first extension flag information is a true value and the second presence flag information is a true value, the circuitry encodes the second video usability information into the second NAL unit.

17. The encoder according to claim 12, wherein
the circuitry, in operation:
encodes image-related information related to an image included in the bitstream into the second video usability information, and
in a case second extension information that further extends the second video usability information is described in the second video usability information, the circuitry encodes, into the second video usability information, size information indicating a size of the second extension information, and
encodes the second extension information into the second video usability information on a basis of the size information.

18. The encoder according to claim 12, wherein
the circuitry, in operation:
encodes image-related information related to an image included in the bitstream into the second video usability information,
encodes, into the second video usability information, third extension flag information indicating whether second extension information that further extends the second video usability information is described in the second video usability information, and
in a case the third extension flag information is a true value, the circuitry encodes the second extension information into the second video usability information.

19. The encoder according to claim 12, wherein
the first extension information includes a bit string continuous up to a terminal bit of an NAL unit that stores the first extension information.

20. The encoder according to claim 18, wherein
the second extension information includes a bit string continuous up to a terminal bit of an NAL unit that stores the second extension information.

21. The encoder according to claim 12, wherein
the second video usability information includes image-related information related to an image included in the bitstream,
in the encoder that does not allow interpretation of the image-related information,
the circuitry, in operation, encodes the first extension flag information that is a false value into the bitstream, and
the circuitry does not encode the second video usability information, the second extension flag information, and the first extension information into the bitstream.

22. The encoder according to claim 12, wherein
the second video usability information includes image-related information related to an image included in the bitstream,
in the encoder that allows interpretation of the image-related information and does not allow interpretation of the first extension information,
the circuitry, in operation:
encodes the first extension flag information that is a true value, the second extension flag information that is a false value, and the second video usability information into the bitstream, and
does not encode the first extension information into the bitstream.

23. A decoding method comprising:
by a decoder,
acquiring, from a bitstream, first presence flag information indicating whether first video usability information is described in the bitstream;
in a case the first presence flag information is a true value, acquiring the first video usability information from the bitstream;
acquiring, from the bitstream, first extension flag information indicating whether second video usability information is described in the bitstream;
in a case the first extension flag information is a true value, acquiring the second video usability information from the bitstream;
acquiring, from the bitstream, second extension flag information indicating whether first extension information is described in the bitstream, the first extension information extending other information of a network abstraction layer (NAL) unit in which the second video usability information is described; and
in a case the second extension flag information is a true value, acquiring the first extension information from the bitstream.

24. An encoding method comprising:
by an encoder,
encoding, into a bitstream, first presence flag information indicating whether first video usability information is described in the bitstream;
in a case the first presence flag information is a true value, encoding the first video usability information into the bitstream;
encoding, into the bitstream, first extension flag information indicating whether second video usability information is described in the bitstream;
in a case the first extension flag information is a true value, encoding the second video usability information into the bitstream;
encoding, into the bitstream, second extension flag information indicating whether first extension information is described in the bitstream, the first extension information extending other information of a network abstraction layer (NAL) unit in which the second video usability information is described; and
in a case the second extension flag information is a true value, encoding the first extension information into the bitstream.
